(19) United States
(12) Patent Application Publication
(10) Pub. No.: US 2005/0260548 A1
(43) Pub. Date: Nov. 24, 2005

(54) Team-based, computer-implemented accountability program

(76) Inventor: Don Nava, Los Altos, CA (US)

Correspondence Address: GLENN PATENT GROUP, 3475 EDISON WAY, SUITE L, MENLO PARK, CA, 94025, US

(21) Appl. No.: 11/105,623

(22) Filed: Apr. 13, 2005

Related U.S. Application Data
(60) Provisional application No. 60/562,363, filed on Apr. 14, 2004.

(51) Int. Cl. A63F 3/00; G06F 17/60

(52) U.S. Cl. 434/219; 705/11

(57) ABSTRACT

The invention provides a team-based, computer-implemented accountability program, for example a program that applies principles of team-based accountability to human wellness and energy.

### CROSS REFERENCE TO RELATED APPLICATIONS

This application claims priority to U.S. provisional patent application Ser. No. 60/562,363, filed 14 Apr. 2004, which application is incorporated herein in its entirety by this reference thereto.

### BACKGROUND OF THE INVENTION

1. Technical Field

The invention relates to human wellness and energy. More particularly, the invention relates to a team-based, computer-implemented accountability program.

2. Description of the Prior Art

Wellness and energy are important personal goals. While the spirit is willing, the flesh is often weak. Thus, most exercise or training programs rely upon an individual either accounting to himself or being motivated by a trainer, or both. Neither approach incorporates a group dynamic and the accompanying synergy into the process, nor does either process overlay a team or group dynamic on an organization. Yet organizations of people, such as at a place of employment or a place of worship, abound and members of such organizations are often in regular contact, even at a distances, due to computer-based communications.

It would be advantageous to provide a team-based, computer-implemented accountability program, for example a program that applies principles of team-based accountability to human wellness and energy.

### SUMMARY OF THE INVENTION

The invention provides a team-based, computer-implemented accountability program, for example a program that applies principles of team-based accountability to human wellness and energy.

### BRIEF DESCRIPTION OF THE DRAWINGS

FIG. 1 is a display of a Web page showing a home screen for the Team of 3 embodiment of the invention;

FIG. 2 shows a member sign-in to the Team of 3 embodiment of the invention;

FIG. 3 shows an activity scheduling page of the Team of 3 embodiment of the invention;

FIG. 4 shows a personal data/activities and tasks page for the Team of 3 embodiment of the invention;

FIG. 5 shows a registration acceptance page for the Team of 3 embodiment of the invention;

FIGS. 6a and 6b show a page, which contains a team clipboard, my clipboard, and activity calendar for the Team of 3 embodiment of the invention;

FIG. 7 shows the team clipboard for the Team of 3 embodiment of the invention;

FIG. 8 shows my clipboard for the Team of 3 embodiment of the invention;

FIG. 9 shows an activity calendar for the Team of 3 embodiment of the invention;

FIG. 10 shows a choose activity page for the Team of 3 embodiment of the invention;

FIG. 11 shows a food guidelines page for the Team of 3 embodiment of the invention;

FIG. 12 shows a team profile page for the Team of 3 embodiment of the invention;

FIG. 13 shows a folders page for the Team of 3 embodiment of the invention;

FIG. 14 shows a team awards page for the Team of 3 embodiment of the invention;

FIG. 15 shows a top teams page for the Team of 3 embodiment of the invention;

FIG. 16 shows a chat room page for the Team of 3 embodiment of the invention;

FIG. 17 shows a log out page for the Team of 3 embodiment of the invention;

FIG. 18 shows an eMomentum™ message according to an eMomentum™ embodiment of the invention;

FIG. 19 shows a status page according to the eMomentum™ embodiment of the invention;

FIG. 20 shows an email message to a participant in the eMomentum™ program according to the eMomentum™ embodiment of the invention;

FIG. 21 shows a member history according to the eMomentum™ embodiment of the invention; and

FIG. 22 shows a team history according to the eMomentum™ embodiment of the invention.

### DETAILED DESCRIPTION OF THE INVENTION

The key elements of a first embodiment of the invention, this Cord of 3, comprise:
Become part of a Cord of 3.
Speak Dictums to yourself daily.
Frame goals in a Ten-Week Cycle.

Following is a definition of each of these concepts.

Develop a Cord of 3

A Cord of 3 is one of the vital concepts at the foundation of The Fit Life. It is based upon a concept in the Bible: “A cord of three is not quickly broken.” (Ecc. 4:12) The first and foremost secret ingredient for the Totally Fit Life program is this:

Align yourself with and commit yourself to the success of two other people who share your goals and your desire for a Totally Fit Life.

What Is a Cord of 3?

In a Cord of 3, three people bind themselves together in a verbal agreement to pursue The Fit Life. There are no contracts, nothing legally binding. The agreement is just person-to-person. A Cord of 3 agreement says, “I want to become more fit. I'm willing to give you encouragement to help you become more fit, and I'm willing to receive your encouragement in return. Let's do this together!”

Every Cord of 3 relationship needs to have one of the three people designated as the “leader.” This is the person willing to say to the other two: “Let's meet at this time in this location” and also to say if necessary, “Hey, team, we aren't living up to what we agreed to do. Let's regroup and renew our commitment.”

What Do Cord of 3 Partners Do for One Another?

Cord of 3 partners do three things for one another:
They define their own relationship and goals as a Cord.
They serve as accountability partners to one another.
They encourage one another.

Let's take these duties one at a time.

Cord of 3 Partners Define Their Own Relationship and Goals as a Cord. They define which aspects of the Fit Life they are willing to pursue “as a team.” They define what they each are willing to do individually as well as what they are willing to do for one another.

Four aspects of this defining process are especially important to consider.

First, the quest for The Fit Life is ultimately an individual quest. You do NOT need to share with your Cord of Three partners your personal goals—only the fact that you have a desire to improve in a particular aspect of your life. Certainly, we all can improve in SOME way in every segment of The Fit Life. None of us are fully where we desire to be, or can be, nutritionally, physically, emotionally, mentally, spiritually, or directionally. In plain language, you don't need to share with your Cord of 3 partners what you weigh, what you want to weigh, or how much you want to lose . . . you don't need to share specifics about what you eat or don't eat . . . you don't need to share specifics about your emotional struggles . . . you don't need to confess any particular faults, doubts, failures, dreams, hopes, or life goals. What you do need to do is to admit to your Cord of Three partners: “I want to improve. I'd like to be in an accountability and encouragement relationship with you.”

Second, the information you share with your Cord of 3 partners should be YOUR information ONLY. This is not the place to tell the foibles of your spouse, the problems you are having with a child, the details of a difficulty at your workplace, or the secrets of a friend who has confided in you. You should feel free to share with your Cord of 3 how you are FEELING about an issue, and you might even share that the issue is related to your career or your role as a parent, spouse, or friend, but do NOT reveal information that might embarrass another person. Your role in a Cord of 3 partnership is essentially “all about you.” It's about your behavior and attitudes.

Third, a Cord of 3 is not a therapy group—in that it isn't the place to get into friend-to-friend counseling about psychological issues or relationships. It is a TASK-oriented group. You are sharing and encouraging one another on specifics that are related to tasks—how you eat, what you do, how much you exercise, and in general, whether you have made progress toward your personal goal or not. You should expect to give and receive encouragement, not counsel, from your partners.

Fourth, a Cord of 3 relationship is likely to be more meaningful to you the more you have in common. Those who work in the same company . . . attend the same church . . . live in the same neighborhood . . . are about the same age . . . are recovering from the same disease . . . or who have children in the same school tend to find that they have greater empathy for the success and failures of their Cord of 3 partners.

The Cord of 3 participant who admits, “I'm having a really difficult time getting up and exercising early in the morning after being up at 2 a.m. feeding a baby” is going to feel even greater encouragement from another Mom who says, “Been there, done that. Here's what worked for me.”

The Cord of 3 participant who says, “I've always struggled with my weight” is likely to respond more readily to a fellow Cord partner who says, “I have, too.”

The Cord of 3 participant who says, “I'm really trusting God for a breakthrough in this area of my life” is going to appreciate a Cord partner who says, “I'm in agreement with you on this—I'm praying for you.”

The Cord of 3 participant who admits, “I know I need to get more physically fit as an example to those whom I pastor” is going to be even more encouraged when he is in partnership with two other people who are pastors motivated by the same “knowing” that they need to work on physical fitness.

I always recommend that Cords of 3 be either three men or three women. Because friendships are likely to emerge, and sometimes, it's too easy for a friendship to slip over the lines of marital fidelity—in other words, it's too easy for words of encouragement to be misread as flirtatious. It's also too easy for two people to “pair off” and leave the third person feeling left out. Even when groups are all-male or all-female, I caution you to be “equal” members of the team and to avoid becoming best friends with one Cord partner to the exclusion of the other.

Let me give you an example about how a Cord of 3 might develop and function.

Sue, Ellen, and Jolene all go to the same church and they agree to form a Cord of 3. They decide that they each have a desire to instill and maintain the following habits into their lives as part of their individual quests for The Fit Life:
Eat right
Exercise regularly
Read the Bible every day
Pray every day

They also decide that they are going to check in with each other six days a week—Monday through Saturday—by e-mail. They agree that they are going to meet at a park every Saturday morning at seven o'clock to walk a school track together and then have a nutritionally smart breakfast.

Cord of 3 partners Serve as “Accountability Partners.” Each day, each person reports to the other two people on each of the “team activities” they have defined. The reporting system can be very simple. In fact, you can make it a checklist more than a narrative report. You don't need to give amounts or details, but can reduce the checklist to yes/no answers.

Some Cord of 3 partners like to make a little form that they just duplicate and tick off every day. Here's one we use in our program:

| | | | | |
|---|---|---|---|---|
| Food | Ate: | ◯ good | ◯ fair | ◯ poor |
| Drink | Activity: | ◯ good | ◯ fair | ◯ none |
| Activity | Attitude: | ◯ good | ◯ fair | ◯ poor |
| Top 1: | ◯ yes | ◯ no | | |
| Quiet Time: | ◯ yes | ◯ no | | |

Here are three very quick examples of a narrative report:

Sue: “I ate good. I walked for 20 minutes on a treadmill and rode a stationery bike for 20 minutes at the gym. I read 1 Cor. 13 and had a prayer time.”

Ellen: “I blew it today—had a pizza. I took the dog for a 30-minute walk in the neighborhood and threw a Frisbee with my son. I read Lev. 14-15 . . . what a downer!. . . and I had a prayer time.”

Jolene: “I worked out at the gym for 30 minutes—weights and stretching exercises that my trainer gave me as a ‘routine.’ I read my Bible and had a prayer time—not as long as I would have liked, but at least something. I ate fair.”

How long does it take to “report in” to Cord of 3 partners? Lots of Cord participants find that it takes less than a minute to report to each partner.

It helps to:
Keep e-mail and phone addresses handy for Cord partners. Over time, you're likely to memorize them.

Keep MOST of the communication short and simple when it comes to basic accountability. If you feel the need of a longer message to ask for help with a specific problem or concern, put it in a second message. Too often a person says, “I'll wait to report in until I have time to share more in-depth about a struggle I'm having”—and the result is that the person fails to report in.

Cord of 3 Partners Serve as “Encouragers” to One Another. Cord of three partners respond to the accountability reports of their partners with encouraging words. You probably can guess what Sue, Ellen, and Jolene had to say to one another.

Sue to Jolene: “At least you're hanging in there. Tomorrow will be better.”

Jolene to Ellen: “Tomorrow will be a better day! I know you can do this! Why not take a break and read 1 John instead of Leviticus!”

Sue to Ellen: “Your dog and your son had a fun day! I believe in you. When my family is begging for pizza, I order one half of the pizza as veggie with no cheese, and then I scrape off just the toppings and eat only two or three bits of crust. It isn't perfection, but it's better than eating five slices of the really greasy stuff!”

Ellen back to Sue: “You are inspiring me. Thanks for your note.”

Ellen back to Jolene: “Thanks. Good idea about 1 John. You are inspiring me to look into weight training.”

Jolene to Sue: “Go girl. You're doing it!”

How long does it take for a Cord of 3 person to write a little e-mail to the other two partners? Probably not more than a minute or two a day.

The Building of Genuine Friendships. You are likely to find that the two people who serve as your accountability partners truly do become friends.

What are some of the characteristics of a lasting friendship? Here are three major ones:
Intimacy of Communication. True friends “hold nothing back.” They are willing to share freely and fully all that they feel, hope, dream, experience, fear, and struggle with. They share their failures as well as their successes, their weaknesses as well as their strengths. A true friend is the person with whom you can share your innermost secrets without fearing their judgment.

The two people with whom you are “corded” are people with whom you need to be very open in your communication. The more open you are, the more you will be able to encourage and motivate one another. Your two partners are people with whom you should feel free to admit:
I'm feeling discouraged.
I'm tired today.
I don't know if I can do this.
I'm struggling with something.
I have some doubts about . . . .
I wish I didn't . . . .
I sure would like to . . . .

They are also people with whom you should not feel at all bashful about saying:
I lost two pounds this week!
I just got into an item of clothing I haven't worn for months.
I had a real breakthrough in my life.
I think I've rounded the bend in my struggle with . . . .
I just thought of something fantastic . . . .
I'm half way to my goal.

Over time as you communicate with your partners in a Cord of 3 relationship you are likely to find that you are looking forward to “reporting in”—by phone or by-email—to your partners. Your communication with them is likely to be a good, safe, satisfying, rewarding nugget of time in your busy day. You will look forward to hearing from them, and communicating with them.

This is especially so, I've discovered, if you have periodic times of meeting together, although Cord of 3 relationships have worked for people thousands of miles apart—some of whom have never seen one another. Three people who walk together five mornings a week . . . three friends who get together for lunch once a week to swap “this works for me” and “wow, that was hard” stories . . . three friends who meet at the gym once a month to have a protein shake after a work-out . . . are people who find that in putting a face to a name, they are discovering more about their own self—their ability to be a friend to a person they might not otherwise have discovered as a friend, a newfound willingness to open up and help someone else or be helped by someone else, and even a willingness to share with someone a struggle, difficulty, or joy that the person may have been very reluctant to “admit” in a face-to-face meeting prior to becoming part of a Cord of 3.

A Delight in Fellowship. A mark of genuine friendship is that you look forward to being with your true friends! Their presence is never a burden to you—only a joy. This doesn't mean that at times a true friend isn't “down” emotionally, discouraged or disappointed with life. Rather, it means that you look forward to being with that friend because you both know that being together will make the “down” time more bearable . . . and you may even be able to lift the spirits of your discouraged friend.

True friends delight in doing things together because they delight in just being together.

Speaking Truth. Friends tell each other the truth. Not only does a friend tell you when you are about to make a mistake or when you are heading for a failure, but a true friend tells you who you are—the higher, better, more noble you. A friend reminds you that you are a creation of God and that you can do more, be more, and experience more of God's goodness than you are presently experiencing.

As a part of speaking the truth, a friend always keeps his word. What he says, he does. You can count on a true friend to be faithful to his promises.

There's no advantage whatsoever in a person lying about how they are feeling, how well they ate, how much they exercised, or what they are believing or dreaming for their lives. Eventually, a lie will be discovered, trust will be broken, and the partnership will seem weak if not useless. You must speak truth to those with whom you are in a Cord of Three relationship.

All of these concepts of friendship are at the heart of being in a Cord of 3.

Must You Be FRIENDS? The question arises: “Do you have to become friends with those in your Cord?”

No. People who are very different in personality, ages, belief systems, and cultures have formed successful Cord of 3 relationships. How can this be?

A Cord of 3 partnership is highly goal oriented, task-based, and for a limited period of time.

We all went to elementary school, junior high, high school, and college with people that did not become our “friends.” We were in reading groups, play groups, and participated in team sports with people who may not have been our close buddies . . . and we did so successfully. We lived in dorms, ate in the cafeteria alongside, and walked the hallways with people who were part of our larger “group”—our school, our club, our team, our association—without having a social relationship with them. Our success in those groups was not only individual success, but many times, group success.

The same is true for a Cord of 3. You don't need to be LIKE your Cord partners. And you don't even need to LIKE them.

But . . . chances are . . . the longer you share together, the more you will find in common and the more you will discover that you are “alike” in ways you didn't know previously. The more you help one another, the more you are likely to begin to “like” your Cord partners.

Team Competition Among Cords

Some people have found it extremely beneficial and motivation to be in a competition—NEVER with their two other Cord partners, but in competition between their Cord and other Cord of Three groups in a larger setting. For example, several Cords might form within a church . . . a company or a local gym. These Cords might then choose to compete for prizes that are agreed-upon in advance. Among the prizes I've seen offered are various pieces of exercise equipment, a half-day at a spa, magazine subs, T-shirts, blenders for making smoothies, concert tickets, a basket of health-related supplements and food items, a gift certificate to a bookstore or sports store, and tickets to a ballgame. One company offered one prize should the competition be won by an all-female Cord, and another prize should the competition be won by an all-male Cord. The women chose the prize for the women, the men for the men. In the end, the women of this company won a free manicure and pedicure (for each woman in the winning Cord), and the men “lost” the opportunity to attend a play-off game by a local college team.

The competition, of course, needs to be based on a uniform criteria—all of the Cords need to be pursuing a similar set of goal sectors. Generally speaking, in the corporate world, the criteria tends to be three-fold:
Eating
Exercising
TOP1

In the church world, the criteria tends to be four-fold:
Eating
Exercising
TOP1
Devotional time (generally a time for Bible reading, contemplation, prayer)

The evaluation devices need to be uniform: good, fair, poor, yes, no.

And the scoring needs to be on the basis of the greatest numbers of GOOD and YES responses over a given time period. A means of breaking a “tie” may need to be established.

Definitions of “good” performance in nutrition and physical activity need to be established for all participants. I recommend, of course, that you use the Totally Fit Life definitions offered later in this book.

All reporting is self-reporting, of course. Every team has to be responsible for its own truth-telling when it comes to reporting eating, exercising, and other behavioral components. Ultimately, a lie is going to be discovered—especially if you say you've been doing aerobic exercise five days a week for thirty minutes a day and then, after ten weeks, you can't walk a quarter of a mile without huffing and puffing!

Sometimes a Cord competition culminates in a fun-run, a family-activity day at a gym, a walkathon for a worthy charitable cause, or a “nutritionally smart” picnic and softball game. This gives groups a chance to openly acknowledge and applaud the winners. Of course, if Cords of Three participants know they are going to be “viewed” face-to-face by other Cords, they are also much more likely to be truthful in their self-reporting!

Practical Suggestions about Competition. Let me make two very practical recommendations. These seem to be especially important “rules” if you are part of a Cord competition in your workplace or church.

First, don't publicize the results of any Cord other than the winning Cord. Build up, applaud, and set up as role models those who are successful. Let others be inspired to follow their example without feeling any condemnation.

Second, honor all who participate in such a competition with words of encouragement and appreciation. Seek out “testimonials” that people may have about the personal benefits of the competition, their renewed total-fitness focus, or their pleasure at making new friends or having accountability partners.

Speak Daily Dictums

A second key “secret ingredient” to making the Totally Fit Life program work for a lifetime is this: Command yourself every morning with a personalized series of daily dictums.

Nobody can command you like YOU.

Call it self-motivation. Call it giving yourself a mental kick into gear. Call it telling yourself the right things to do. Call it whatever you like . . . but do it.

Command yourself.

Charlie did.

I have a friend who told me about meeting Charlie at the gym where she goes. They seemed to show up at the exercise bicycles at the same time on Mondays, Wednesdays, and Fridays. They've developed a friendship. Charlie is in his mid seventies and my friend, who is about fifty, said to him one day, “Charlie, I really admire you for coming here so regularly.”

He said, “It's not because I want to.”

“Oh?” she said.

“I sometimes find myself sitting in my big blue leather chair about one-thirty in the afternoon and I'm just about to doze off, when I hear myself saying, ‘I need to take Jake for a walk.’”

My friend said to me, “Coach, at that point I truly thought he was talking about taking his dog for a walk. I said to him, ‘Charlie, what does that have to do with coming here?’”

Charlie said, “Jake and I walk ourselves here.”

“But I never see him tied up anywhere outside,” my friend said.

“Who?”

“Jake.”

Charlie laughed and said to her, “My middle name is Jacob. I take myself for a walk, Missy, right out to the car and three miles over here and into the gym.”

It was my friend's turn to laugh.

“I take Jake a lot of places he thinks we need to go,” Charlie said. “I take him to synagogue when I don't feel like going. I take him to my sister's house for dinner when I don't feel like going all the time—she smokes, you know. I do things for Jake all the time that I don't want to do, like cook for him.”

“You'e lucky to have Jake,” my friend said, whose name is not Missy, by the way.

“Lucky!” Charlie spewed. “No luck about it, Missy. Jake makes me do it. He says we've got to stick together for another fifteen years, maybe twenty. I do what he says.”

Charlie said all this with a twinkle in his eye, my friend told me. He wasn't crazy, fantasizing about an imaginary friend, or hearing voices. He was as sane as a person can be. And he is also very disciplined.

Charlie Jacob tells himself day in and day out that he HAS to do things he doesn't particularly want to do. He is a healthier man for it. I would love for him be part of the Totally Fit Life program.

You Make the Dictums. Let me share with you a few things about what it means to command yourself with a series of dictums. In the first place, let's define dictum. A dictum is a formal, authoritative pronouncement. It's a statement of intention that has been determined fully and that will be carried out. It's not just a whim or a dream or a hope. It's a firm commitment rooted in a conviction that what you are pronouncing is going to happen.

In sum, a dictum is an “I WILL” statement applied to very specific things that you seek to do in a given day.

You decide the dictums. You are the one who settles on the pronouncements that declare not only what you INTEND TO DO, but what you firmly believe you MUST do and that you WILL do. You are the one who determines how often you must do these things, in what ways you want to do them, or to what degree of excellence you will do them.

You decide the tasks that you want to fold into your life . . . the habits you want to develop . . . the changes you want to make . . . and the practices you want to adopt.

You set the timetable or frequency for acting on any given dictum. Once a day, once a week, three times during the week and once on a weekend, whatever works to turn the pronouncement into reality. It's up to you. If you have settled on a dictum, you have an idea of what it will take to be successful in its adoption.

You set the standards of performance.

Unless you set dictums for yourself, you won't follow through on them. You'll find every excuse you can to justify your rebellion against someone else who is nagging you, or telling you what to do. The point is, nag yourself.

I strongly recommend that you:

Identify at least three and no more than twenty dictums that are deeply important to you. You will be guided as the chapters progress to write out these dictums for EACH area of fitness.

Some of the dictums may reflect things that you are already doing, but desire to do more frequently. Some of the dictums may be mental or attitudinal habits that you know are essential if you are to reach your goals in life. Some of them may be new habits that you want to develop because you deeply believe you should develop them.

Write out your dictums. In writing your dictums, use the phrase I WILL and add the word TODAY whenever possible. You might also make your dictums into statements about the “state” of life you choose to adopt—such as “I am confident” or “I seek the best in all things.”

Use short, crisp sentences. You don't need to give long reasons for why you have decided upon a particular dictum. You know the reasons—and as time goes by and these dictums begin to be an automatic part of the way you think and behave, you'll probably find additional reasons for enacting your set of dictums.

Below are some sample dictums from my ongoing, personal, growing collection of personal dictums. They are offered to you to give you an idea of what you might write and the way in which a good dictum is written.

Sample Dictums

I WILL spend some time in prayer TODAY.
I WILL eat good and healthful food TODAY.
I WILL exercise TODAY.
I WILL drink sufficient water to keep my body well hydrated TODAY.
I WILL speak positively about exercise TODAY.
I WILL choose to think about positive things TODAY.
I WILL get to sleep at a good hour TODAY.
I WILL put another person “first” TODAY.
I WILL read uplifting and inspirational material TODAY.
I WILL read aloud my master list of goals for this month TODAY.
I AM becoming more and more fit with each passing day.
I AM a person worthy of experiencing a Totally Fit Life.

Your Dictums Should Reflect Your Priority Goals. When it comes to goals, most people have a wide range of goals. A woman once showed me a list of goals she keeps in her day-timer. Among the items on her list were, “Travel to Iceland. Try cross-country skiing. Lose forty pounds. Re-learn how to play the piano. Take a gourmet cooking class.”

Iceland? It's not on my list of things to do in my lifetime, but that's the good news—every person has a different set of goals. Those goals tend to change over time . . . new goals are added, accomplished goals are deleted, old goals are revised, some cease to be of interest.

What we find in the Totally Fit Life program is that the things you write as your dictums reveal who you want to BE and how you want to live your life in a general way. In very meaningful ways, your dictums reflect your Priority Goals in life.

For the friend I mentioned above, priority goals were perhaps more broadly stated in these terms: Stay active. Stay interested in other people, places, and things. Keep learning. When she realized these were among the real priorities of her life, she wrote additional dictums:
I WILL read something informative TODAY to broaden and enrich my mind.
I WILL seek to meet new people and explore new places . . . I WILL be open TODAY to new encounters and possibilities.
I WILL exercise TODAY.

Make a List of General Goals. We will get into this a little later in the book but I encourage you at the outset to make a list of those things that you see as general goals for your life. Include things you want to do as well as traits you want to develop in your life. You might include people you'd want to have as friends, places you'd like to go, things you want to accomplish or experience, and items you'd like to own. Make the list as long or short as you desire.

I recommend that you put the list aside and then pick it up a week or so later . . . or at least a day later. Reevaluate what you have written. Circle those things that you consider to be absolute MUSTS in your life. These are your Priority Goals. As you write out your dictums, make sure your dictums have a close relationship to your Priority Goals . . . and make sure that no dictum is in contradiction to or is a conceptual violation of a Priority Goal.

Select Your Three Top Dictums in Each Category of Fitness. The Totally Fit Life program calls for you to speak THREE DAILY DICTUMS to yourself each morning in EACH AREA OF FITNESS. That's a total of eighteen statements you are commanding yourself to do every day.

Do eighteen statements sound like a lot? I guarantee you that if you have them written out, you can run through that list in less time than it takes for a “commercial break” in your favorite television program. Think of it this way—if you're going to buy something, buy into these good concepts of your own creation!

You can read through eighteen statements in two long traffic lights.

A woman with long hair can read through eighteen statements in the time it takes to blow dry her hair.

A man can read through eighteen statements in the time it takes to shave—reading one or two statements with each cleaning of the razor.

A person can read through eighteen statements in less than a minute!

Your TOP THREE DICTUMS should reflect the top three habits that you want to develop in your life in each area of your life—they are habits you want to begin, renew, or strengthen. For most people, three of these dictums are likely to be:
I WILL eat good TODAY.
I WILL exercise TODAY.
I WILL pray TODAY.

How do I know this? Because these dictums are in keeping with what the majority of people I know establish as priority goals: lose weight, get fit, grow spiritually.

I also recognize these as three of the top dictums because the vast majority of people I encounter in the Totally Fit Life program haven't truly developed these three dictums as habits! Some people have a regular habit of praying every day. Some exercise every day. Some eat “good” all the time. If that's the case, you may want to identify other dictums. Again, YOU decide YOUR dictums.

Consider Your Top Eighteen Dictums as Your “Starting” Dictums. Nobody can pursue too many goals simultaneously. Nobody can set for themselves too many daily “things I must do” agenda items. Some things we have just automatically folded into our lives. These are things that are already habits. Dictums are those things that you want to establish as habits, or strengthen as habits.

A friend of mine once told me that she made a dictum of “I WILL floss my teeth TODAY.” She said, “Coach, I didn't grow up with this habit. My dentist and others have told me that good dental hygiene is important not only to teeth-and-gum health but to overall health. I made this a dictum. It took me almost a year to adopt this habit fully into my life so that I didn't have to think about it any longer. Now I floss my teeth automatically. I've moved on to replace this dictum with a different ‘starting dictum.’”

Voice Your Dictums with a Command Tone. The important principle about voicing dictums is that you COMMAND yourself first thing in the morning: I WILL . . . TODAY.

Every person I know has a “command” tone of voice. You may like to think that you don't, but if you are a parent, I can almost guarantee that you have a “command” tone.

Speak your dictums in a command tone. Speak them out loud. Don't just think them, In speaking them you are both thinking them and reinforcing your thinking of them simultaneously. Speak the commands with some emotion. Think of yourself as your own drill sergeant.

The best time to voice dictums to yourself is early in the morning. Even if you have never been in the military, you certainly have seen enough movies about military life to imagine a sergeant coming to your barracks to command: “Rise and shine. Get moving.” Speak to yourself first thing as you get out of bed. Set the tone for your entire day.

How Often Do You Speak Your Dictums? At LEAST once a day. As I mentioned above, I recommend that you voice your daily dictums first thing in the morning.

But, you certainly should feel free to voice these dictums to yourself repeatedly through a given day . . . perhaps before you eat lunch . . . perhaps before you start your car for your commute home from work . . . perhaps right before bed. The FREQUENCY of your repeating your daily dictums is up to you.

Ten-Week Cycles

Many people find the concept of “change the way you live forever” a bit daunting. They WANT to make such a change—they just don't think they can. When I ask people, however, “Do you think you can do this for TWO weeks?” I have yet to get a “No, I don't think so” answer The vast majority of people say YES to my question, “Do you think you could discipline yourself to do this for TEN weeks?” Beyond that, the commitment tends to get iffy.

The Totally Fit Life program calls on you to make goals for yourself—and your Cord of Three—on a ten-week cycle.

This same cycle holds for the formation or ongoing status of a Cord of 3.

This same cycle holds for what you choose as your top three dictums in each of the areas of fitness.

In summary:

Every ten weeks—Renew or Change your Cord of 3
Every ten weeks—Renew or Change your Daily Dictums
Every ten weeks—Renew or Change your Top-Priority Goals

As a part of making your decision to remain in the same Cord of 3 or choose a new Cord of 3, you need to make decisions AS A CORD about the priority goals you want to set for yourselves.

When it comes to your making personal goals or determining personal dictums, you need to make a basic decision whether to add, delete, or keep what you have been reciting and pursuing. Regardless of your choice, you need to make an intentional NEW COMMITMENT to pursuing those goals and reciting these dictums for the next ten weeks.

The advantages of the ten-week cycle are these.

First, there's a surge of motivation involved every time you adopt or re-adopt a goal. If you have failed to be as consistent as you want to be in your pursuit of a goal, the ten-week mark gives you a fresh start to gear up again, make a renewed commitment, climb back on the bandwagon, and give the goal another shot!

Second, the ten-week mark gives you a good amount of time to see if something is truly a priority for you. If you only pursue a goal for a few weeks, you may not have given a good effort to the pursuit. It takes about ten weeks for you to KNOW if a belief is really a belief, a goal is really a priority goal, a dictum is really what you want to become. Periodically we all need to step back and take a look at our lives and goals. We need to reevaluate our use of time, resources, and the commitments we make.

It doesn't take long to review a list of priorities and goals. Give yourself a half hour of “alone time” to take stock of what you've done and what you haven't done, reflect upon why you may have failed in some areas, and renew your commitment to those things that you see as patterns of success or growth.

Third, the ten-week cycle gives you an opportunity to end a Cord of 3 relationship that may have become uncomfortable to you . . . for any number of reasons. You may have come to feel “left out” by the other two partners. You may feel “out of sync” with the goals they want to set for the next ten weeks. You may have found other people with whom you would like to develop a Cord of 3 relationship. Don't hang onto a relationship just because you are fearful of bailing out or hurting feelings. Don't feel guilty for ending a Cord of 3 accountability relationship with a particular set of partners. You don't need to give long excuses or have a tearful parting. You DO need to be honest and upfront in saying, “I think I'm going to opt out of this Cord of 3 Three. I appreciate what you have contributed to my life. I hope you won't have any difficulty replacing me.” Then, DO seek to establish another Cord of Three for yourself!

I encourage you never to speak ill of those who have been Cord of 3 partners with you. You will only be sending a signal to other would-be or current partners that you may not be a reliable partner or a partner who can keep a confidence.

Fourth, the ten-week cycle is a good length of time for instilling a new habit into your life. Behavioral-modification experts have long held to the opinion that it takes at least this long truly to engrain a new habit in an adult human being. This holds for both mental habits and physical ones. It takes ten weeks to see a change in your body as the result of daily exercise. It takes ten weeks to adjust your eating so you no longer have intense cravings; it takes ten weeks to cleanse your system of certain toxins and to renew your ability to taste certain foods (without the overlay of too much sugar, fat, or chemical preservatives). It takes ten weeks to imprint a new idea on the mind. Give yourself ample time for the GOOD things you are doing to take hold!

A Sequence of Cycles. The ideal, of course, is for you to choose to re-up your Cord of 3 and to renew your commitment to certain daily dictums and priority goals and move forward on the same path you have been walking.

Those who re-up for a second ten weeks very often find it much easier to re-up for a third ten weeks. By then they are starting to see real change and to establish a deeper relationship with their Cord partners.

A significant change happens to those who re-up for a fourth cycle and complete it. I can't explain why this is so, but I know from years of experience that something truly transformative occurs at the forty-week mark. It is then that habits truly seem to be ESTABLISHED . . . thinking seems to settle decidedly into a more positive pattern . . . emotions truly seem to be healed . . . and enough progress has occurred for a person to feel really GOOD about what he is doing.

After four cycles, it is often the case that a Cord of 3, or an individual will say . . . “Hey, just one more cycle and I will have done this for a year!” People who have been faithful to the program seem to see an imaginary “Finish Line” looming before them and they are eager to accomplish an entire year of discipline, accountability, and growth. Once a year is over, it's not at all uncommon for a Cord of 3 to say, “Let's go for another year. We're on a roll.”

Is there ever a time when a Cord of 3 MUST stop being a Cord? No. You can and should stay as a Cord of 3 as long as that Cord is strong and you each desire to contribute to the lives of your Cord partners, and in return, receive from them. If a Cord relationship grows stale, consider a change. In all likelihood, however, if you stay together for longer than a year, you are going to be staying together because you truly have created a friendship. Friendships have peaks and valleys, but true friendships remain. That same principle may very well hold for your Cord of 3.

Is there ever a time when a specific Priority Goal or a dictum should be dropped? Certainly. If your priorities shift dramatically as you pursue the Totally Fit Life . . . if you undergo a real spiritual awakening, a genuine emotional healing, a major adjustment in your thinking, and so forth . . . you may find that your old goals just aren't goals any longer. Make new goals that are in keeping with the new you!

However, don't drop a goal with careful consideration of the goal. If you thought enough of a goal to give it a ten-week effort, there was something about that goal that your perceived to be part of your reason for living. Evaluate what it is that you are REALLY seeking and why. A good Priority Goal is likely to be a goal you have all your life.

Vacations and Days of Rest. Five cycles of ten-weeks each only adds up to fifty weeks. What about the other two weeks? Take them as a vacation!

Some people who have two weeks of paid vacation a year at their job take the entire two weeks in one lump. Others take one week breaks. Still others take a few personal vacation days periodically and string out the two weeks into four or more mini-vacations.

Whatever works for you in your ten-week cycle . . . and whatever works for your Cord of 3. choose that method of taking a break. Many Cords seem to take off the last two weeks of the year as a vacation—they truly take a HOLIDAY!

I also strongly encourage you to take off one day a week as a “free day.” Call it a Sabbath day if you want. Call it a “break day.” Call it whatever you like. But establish with your Cord that you will NOT call, or e-mail, your Cord of 3 accountability report on a particular day each week. Again, this serves as a pause that refreshes . . . gives an opportunity for reflection . . . and allows for a renewal of commitment and a fresh-start for motivation.

What about days when you simply cannot report to your Cord of 3? Perhaps you are going on a vacation with your family and won't have access to e-mail. Perhaps you are leaving the country for a business trip and won't even have access to a phone for awhile. Discuss the matter with your Cord and determine what you WILL do to keep track of your progress and “check in” with your partners upon your return. Be faithful in doing what you commit to do.

A Final Word about Lasting Change

What is needed for a change to be lasting?

Lasting change in habits and life patterns is only achieved when those changes are socially reinforced. In other words, when you are part of a group of people who are doing what you are doing.

Lasting change also occurs when you recognize that what you are doing has a higher purpose. As I state throughout this book, the real purpose of living the Totally Fit Life is to have the strength, energy, and health to do all that you inwardly know you are supposed to do in your life. It is having the physical, nutrition, emotional, mental, directional, and spiritual fitness to fulfill your life's purpose.

Lasting change also occurs when you experience positive results. In many ways, the good aspects of the “change” are all the motivation necessary to continue on the upward-and-onward path. In other cases, change needs to be reinforced with tangible and concrete rewards.

I'm a huge fan of rewards. The rewards, however, need to be ones that are healthful and helpful. For example, don't reward the progress you make toward Nutritional Fitness with an ice-cream sundae! DO reward your progress with an afternoon at a spa.

One of the most fun aspects of being part of a Cord of 3 is the establishment of rewards for your Cord. Find fun things to do together. Or if your Cord partners live miles away, find something that you believe would be rewarding to each of you and then “report in” about the fun you had. One Cord of Three rewarded themselves with a visit to see each other after they had been together as a Cord for a year and had successfully met a series of goals.

The Coach's Coaching

Choose to give and take from other people—align yourself with a Cord of 3 and hold on tight!

Choose to speak to yourself what you WILL do and therefore, what you WILL become.

Choose to set goals for yourself and pursue them, pausing occasionally to reevaluate your priorities and renew your commitments.

A Concept to Remember

All things that are truly beneficial happen WITH other people . . . flow from the INSIDE OUT . . . and occur OVER TIME.

Team of 3

The Team of 3, another embodiment of the invention, is a personal accountability program between three individuals (IBOs) in the same business.

The purpose of the Team of 3 is to encourage IBOs to take vitamins and supplements 7 days a week, 2× a day, to exercise 3 times a week and to create High Performance Teams using the Team of 3 Program and the Champion Challenge™.

How is a Team of 3 formed?

One IBO invites two other IBOs already in his/her business to be part of his/her Team of 3 and to take the 10-week Champion Challenge with him/her.

The 3 IBOs communicate with each other on a daily basis either by Genie or by e-mail. These short “I DID IT” messages convey to each other that they took their vitamins and supplements 2× that day. Three of those messages during the week should also include an “I DID IT” for exercising that day using the NeTMOR Portable Fitness Program.

The PV Explosion!

During each 10-week cycle of the Champion Challenge all 3 IBOs are encouraged to invite Two Other IBOs, already in their business, to take the NEXT 10-week Champion Challenge cycle with them.

Teams of 3 that successfully complete the 10-week Champion Challenge are recognized on stage together at major functions. There is no additional cost to be on a Team of 3.

Step 1: You and your spouse, EACH, invite 2 IBOs already in your business to be part of your Team of 3 and to take the 10-week Champion Challenge with you.

Step 2: Start your Team of 3 THE DAY you and your teammates sign up for the Champion Challenge:

Take vitamins and supplements, 7 days a week, 2× a day.
Do the NeTMOR 15-minute Spark Plug workout, at least 3 days a week.
Send a daily “I DID IT” message by Genie or e-mail to your two teammates.
EVERY 7 DAYS, update your weekly Challenge in the Champion Challenge section of the NeTMOR web site.
   Step 3: DURING EACH 10-week Champion Challenge, invite 2 OTHER IBO's already in your business to take the next 10-week cycle with you.
   TOP 1™—The Other Person First
   Why TOP 1?

In a world that is saturated with self-indulgence, TOP 1, The Other Person First, is a fresh wind that will help blow this stale layer of pollution from our communities. TOP 1 is a prescription for a society that is unraveling with the “me only” virus.

From an early age we have heard from parents, teachers, coaches and ministers that “it is better to give than to receive” but never has there been such a simple, non-threatening, non-religious application of this statement until TOP 1.

In a culture where marriages and families are being ripped apart, TOP 1 is a healing agent for keeping and bringing husbands, wives and children back together. TOP 1 begins with an individual making a decision; a decision to make TOP 1 a way of life.

Wellness Dictum

Print a copy of the Dictums below to take with you throughout the day:

A Dictum is a formal, authoritative pronouncement, an unwavering statement of intention, a firm commitment, rooted in a conviction, that what you are declaring is going to happen.

Suggestion: Read the Wellness Dictum OUT LOUD every Morning-Noon-Night.

Experts agree that in order to maximize the power of Dictums, they need to be fueled by emotion and passion. They should not just be repeated mindlessly.

A person needs to concentrate and stay focused when reading the Wellness Dictum. It must be read as if it has already changed your life.

The Dictums

I love my body
I am healthy
I like TO exercise
I choose to live in good health today
I Visualize Perfect Health
My Muscles Are Strong
My Body Is Strong
I develop good lean muscle mass easily
I choose health
I Visualize Cellulite Away
I breathe deeply
My cardiovascular system is strong
Exercise is fun
I am good
I love my body
My muscles are growing
I Visualize THE BODY I WANT
I exercise regularly
I enjoy DEVELOPING MY MUSCLES
I LIKE MYSELF
   Wellness Dictum—Christian Version—

The Wellness Dictum may be provided for many different organizations. For example, the following is a Christian version of the Wellness Dictum.

Print a copy of the Dictums below to take with you throughout the day:

A Dictum is a formal, authoritative pronouncement, an unwavering statement of intention, a firm commitment, rooted in a conviction, that what you are declaring is going to happen.

Since we have a great high priest who has gone through the heavens, Jesus the Son of God, let us hold firmly to the faith we profess. Hebrews 4:14

Suggestion: Read the Wellness Dictum OUT LOUD every Morning-Noon-Night.

Experts agree that in order to maximize the power of Dictums, they need to be fueled by emotion and passion. They should not just be repeated mindlessly.

A person needs to concentrate and stay focused when reading the Wellness Dictum. It must be read as if it has already changed your life.

The Dictumss

I surrender to the Holy Spirit today
I like TO exercise
I like my body
I am healthy
I Visualize EACH MORNING THE BODY I WANT
My Body Is Strong
I think about whatever is true
I develop good lean muscles easily
I choose health
I think like Jesus thinks
I ACT LIKE JESUS ACTS
I like my body
My cardiovascular system is strong
I am good
I Visualize EACH NIGHT THE BODY I WANT
I enjoy DEVELOPING MY MUSCLES
I eat good and healthy food today
I drink water to keep my body well hydrated
I like myself
I present my body to THE HOLY SPIRIT for His purposes

The invention is primarily concerned with a computer implemented accountability program having the various program components set forth in detail above. The following discussion and associated figures set forth presently preferred embodiments of invention.

The online accountability system supports and expresses in an online digital format, to the extent presently practicable and technically possible, the Team of 3/Cord of 3 concept using the common mediums of http/html, Web browser, and Web and database server working in concert with application and presentation logic contained in a 3-tier business model (described below).

Technical Overview: The online accountability system is designed to be made available in three configurations: as a platform for integration into existing systems by competent technical administrator(s), as a customizable system for non-technical administrator(s), and as a stand-alone turn-key system allowing for (but not requiring) technical administration or customization.

The online accountability system is built on a 3-tier business model. The online accountability system is pre-populated with a set of proprietary and (in some cases) trademarked information for at-will application by the consumer. In addition, in certain cases, the application source code, i.e. the specific program source files used to create the binary modules, may be provided to the end-user.

The first tier of business logic, is comprised of all database constructs including highly-customized structures, tables, pre-compiled stored procedures, and numerous processes for data management and maintenance; these are developed primarily for and in Transact/SQL specifically for versions of Microsoft SQL Server 2000 or newer, but are designed to be highly portable and may therefore be applied to similar database engines, such as DB/2, MySQL, using similar versions of the SQL language. The data are not amalgamated in any way; each transaction or report is stored at a line-item level, allowing for full click-through reporting down to the transaction item level at point-in-time. In addition, import and export capabilities to/from standard formats (.csv, .txt, XML, and others) are present to allow integration with existing systems for purposes of data interchange including, but not limited to, ODI and EDI. The stored procedures are secured and may not be modified by the end-user without permission. All tables, stored procedures, and database functions used are proprietary and have been developed uniquely, specifically and solely for the Team of 3/Cord of 3 Online Accountability System.

The second tier of application logic, is comprised of binary executable files and proprietary, custom programming code of various languages (SQL, C#, Visual Basic, and Java/Javascript, PHP); the application logic includes unique, proprietary, and highly-customized source code for the binary application files, custom installers, and modules specifically designed to support each node of the Team of 3/Cord of 3 concept. These modules include, but are not limited to: user profiles, teams, pods, activities, dictums, health/fitness resources (and storage), daily planner, goals, rewards, user/team/pod/system reporting, system administration, bulletin board/blog, metrics, fitness/health curriculum delivery and testing, and a reminder or tickler system code-named HOUND.

Each module is an individual application; that is, each may be implemented independent of any other. However; there is complete integration between the modules. It may be easiest to think of it in terms of a traditional financial accounting system; a company may use only Accounts Receivable, or choose to use the General Ledger and Accounts Payable as well. The modules include all logic required to add, edit, update, and retrieve information as generally indicated by module name. The activities module enables the user to create a wide variety of activities and controlled responses using a pre-determined set of response types (drop-down lists, radio buttons, checkboxes, etc . . . ). The metrics module enables the end-user to create a wide variety of measurement systems for quantifiable items, such as weight, blood pressure, lipids, etc., on a pod/team/personal level. The HOUND module includes APIs to send email, fax, text messages, or voicemail depending on user selection and setup. The HOUND module is fully configurable at the system level, and uses generic third-party telephonic interfaces meeting TAPI standards. The invention encompasses all modules attendant to the system core—made up of the System Administration, Profile Manager, and Activities modules. At present, a pre-existing third party application (ubb.classic and ubb.threads (a set of Perl Scripts)) is used for some user interaction, including bulletin board creation and presentation. These scripts, and their attendant presentation logic, have been highly modified and customized for integration in the Team of 3/Cord of 3 system. With this singular exception, all modules, including numerous small executables and code not listed for the sake of brevity and clarity, have been developed uniquely, specifically and solely for the Team of 3/Cord of 3 Online Accountability System.

The third tier presentation logic, is comprised of several disparate elements which, functioning together, present the combined business and application logic (“back end”) to the system user in common access through internet browsing software (Internet Explorer, Netscape, et al.). The most significant of these elements are: user controls, custom graphs and graphics, skins and stylesheets, and page templates and construction elements. User controls provide programmatic access to the application logic for technically-competent Website designers and engineers who wish to implement the Team of 3/Cord of 3 System in existing Web sites and other systems. The user controls are also consumed by all three implementation phases of the system. Certain highly-customized graphs and graphics have been created to aid in the display of system items and in system navigation and display of user data. These graphs and graphics are developed solely for use in the Team of 3/Cord of 3 System, and are proprietary. Skins and stylesheets are elements designed to apply a standard look, layout, and feel to each page presented within the system framework. A default set of skins and stylesheets, including type treatments, page layouts, graphic items, and item style treatments, has been developed uniquely and specifically for this application, is provided with the system. The consumer may replace or modify these, but the default set of skins and stylesheets, made up of logic, design, and stylenames is proprietary. The default page templates and construction elements are comprised of text, applications, binary files, and hypertext markup language which, working together, create a finished display page using the aforementioned skins and stylesheets, custom graphs and graphics, and user controls to display data revealed and managed by the application (second tier) and business (first tier) logic. In addition, custom reports and interfaces have been created allowing the graphic or tabular display and output of report data at a fully-granular level. All elements related to presentation logic have been developed uniquely, specifically and solely for the Team of 3/Cord of 3 Online Accountability System.

Thus, the presently preferred embodiment of the invention is implemented as follows:
1) The purpose of the Online Accountability System is to support and express in and online digital format, to the extent presently practicable and technically possible, the Team of 3/Cord of 3 concept using the common mediums of http/html, web browser, and web and database server working in concert with application and presentation logic contained in a 3-tier business model.
2) The Online Accountability System is designed to be made available in three configurations: as a platform for integration into existing systems by competent technical administrator(s), as a customizable system for non-technical administrator(s), and as a stand-alone turn-key system allowing for (but not requiring) technical administration or customization.
3) The three tiers in the Online Accountability System are business logic (containing all database layouts, format, compiled SQL stored procedures, miscellaneous files and applications); application logic (containing all custom executable and source code files to interact between the web server and database engine); and presentation logic (containing all elements essential to display and management of items in the database).
4) The Online Accountability System is comprised of modules including, but not limited to: user profiles, teams, pods, activities, dictums, health/fitness resources (and storage), daily planner, goals, rewards, user/team/pod/system reporting, system administration, bulletin board/“blog”, “metrics”, fitness/health curriculum delivery and testing, and a reminder or tickler, code-named HOUND.
5) The system is pre-populated with basic Team of 3/Cord of 3 Elements and constructs, including a stock set of Dictums, Activities, and Goals, as well as a sample dataset for use in the tutorial/learning process.

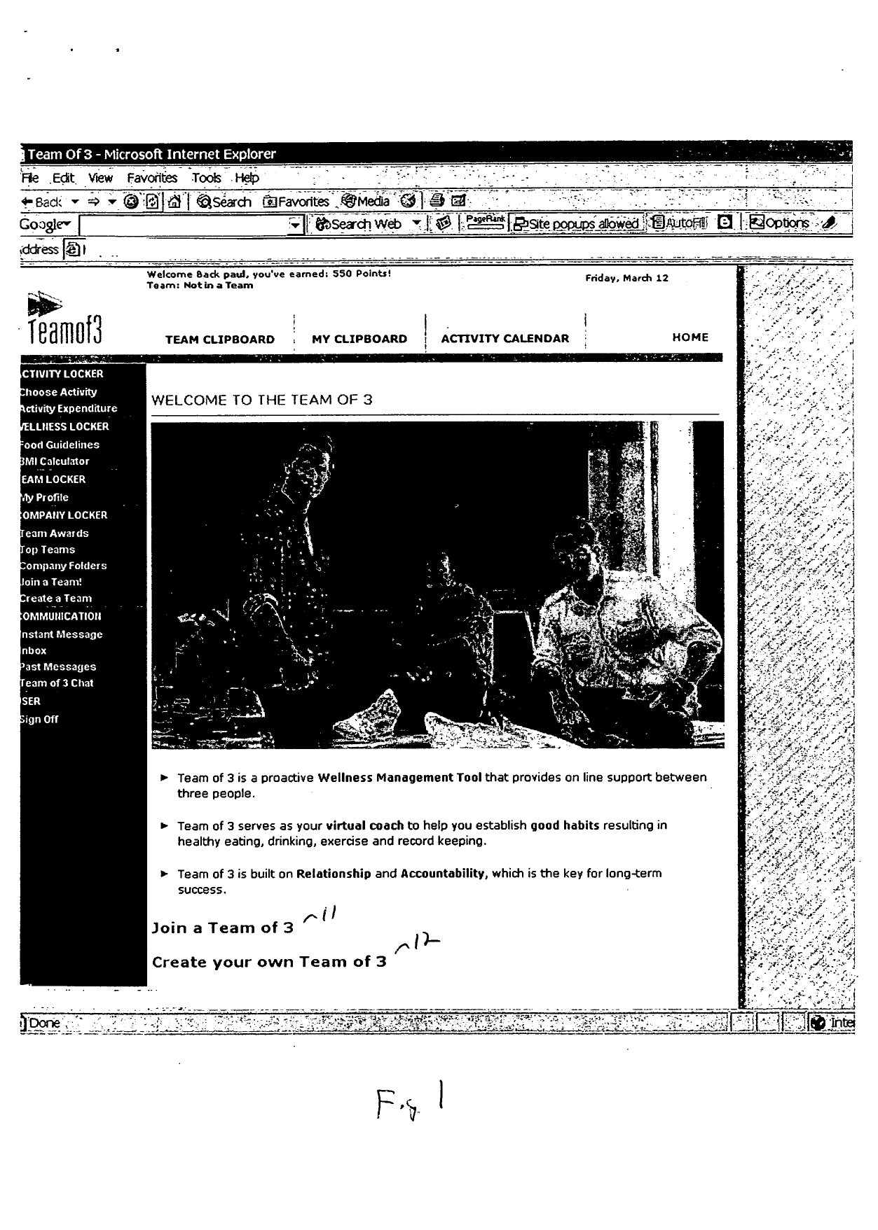

One embodiment of the invention concerns the Team of 3 concept discussed above. FIG. 1 shows a welcome page to the Team of 3 Web site. When a user points a browser to the Team of 3 Web site he is provided with information about the Team of 3, e.g. that the Team of 3 is a proactive wellness management tool that provides online support between three people; that the Team of 3 serves as a virtual coach to help establish good habits resulting in healthy eating, drinking, exercise, and record keeping; and that the Team of 3 is built upon relationships and accountability, which is the key for long-term success. The user is offered the opportunity to join a Team of 3 11 or to create his own Team of 3 12.

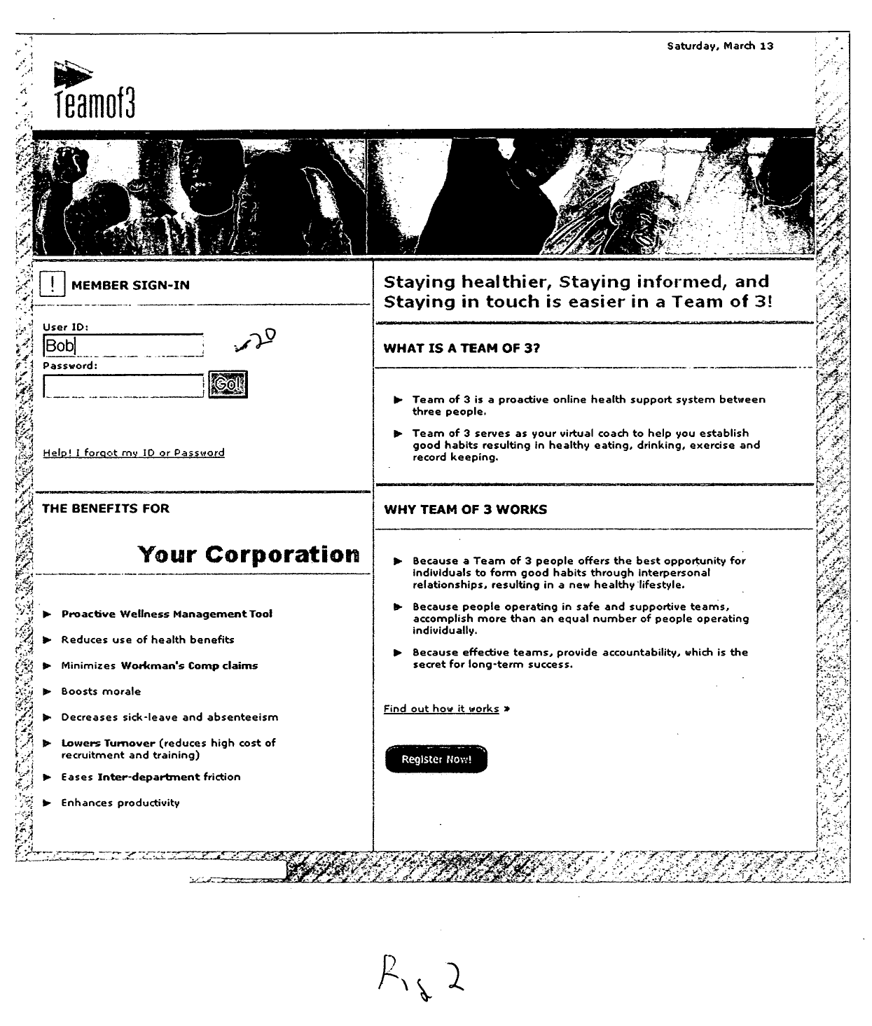

FIG. 2 shows a member sign-in Web page for the Team of 3 embodiment of the invention. As with most applications, the user signs in by entering a user ID and password.

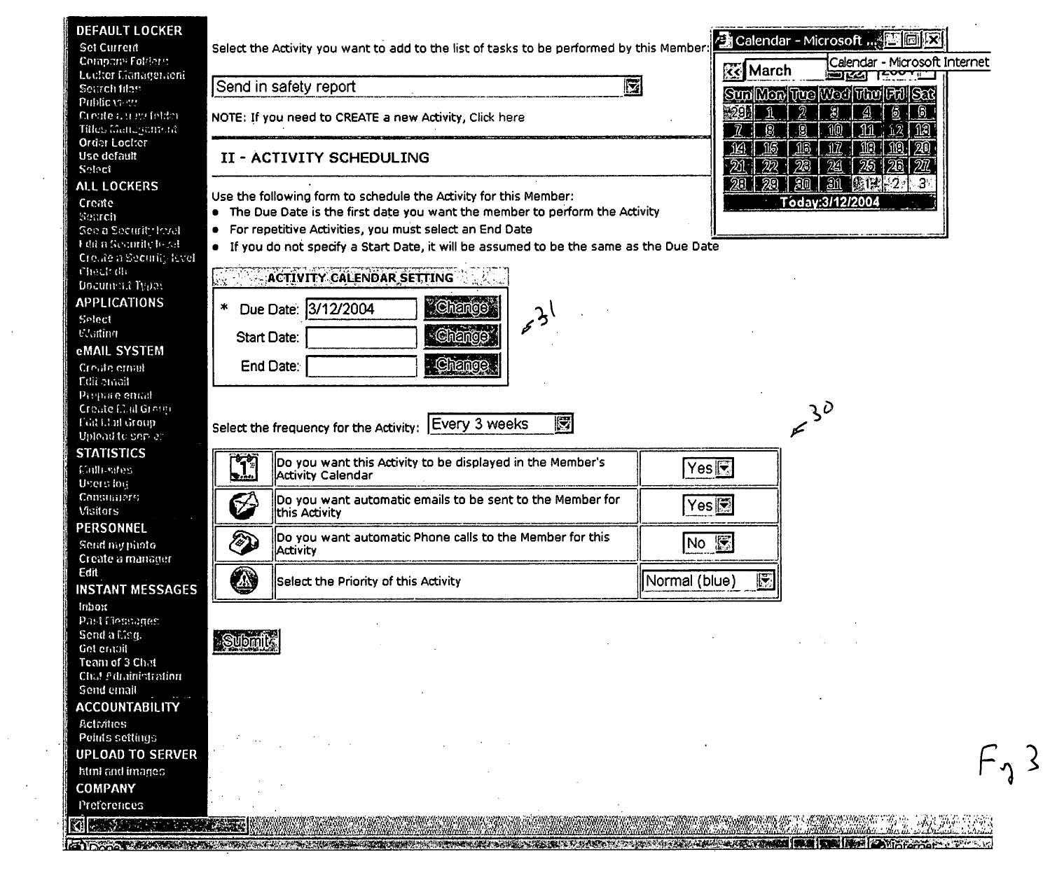

FIG. 3 shows an activity scheduling page by which team member's activities can be scheduled 30, 31.

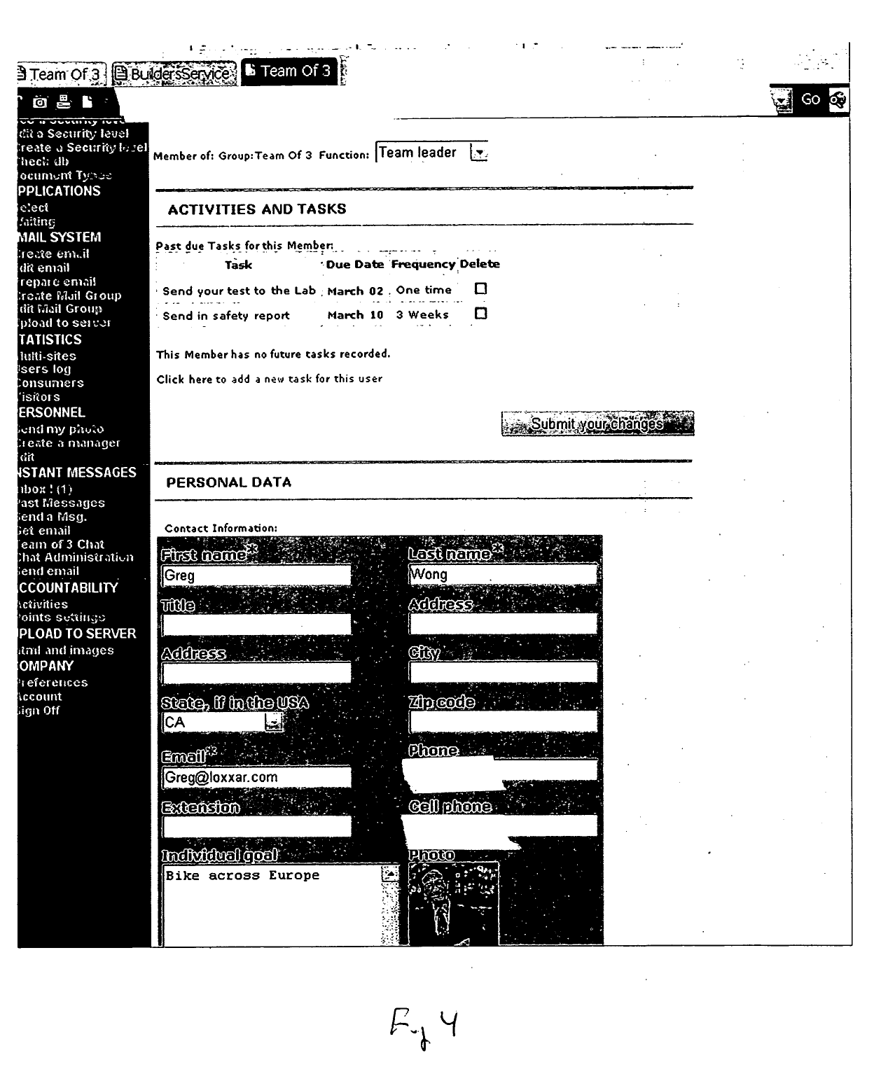

FIG. 4 shows a personal data page for a team member. The personal data page contains a plurality of fields that hold such information as the user's name, address, and the like.

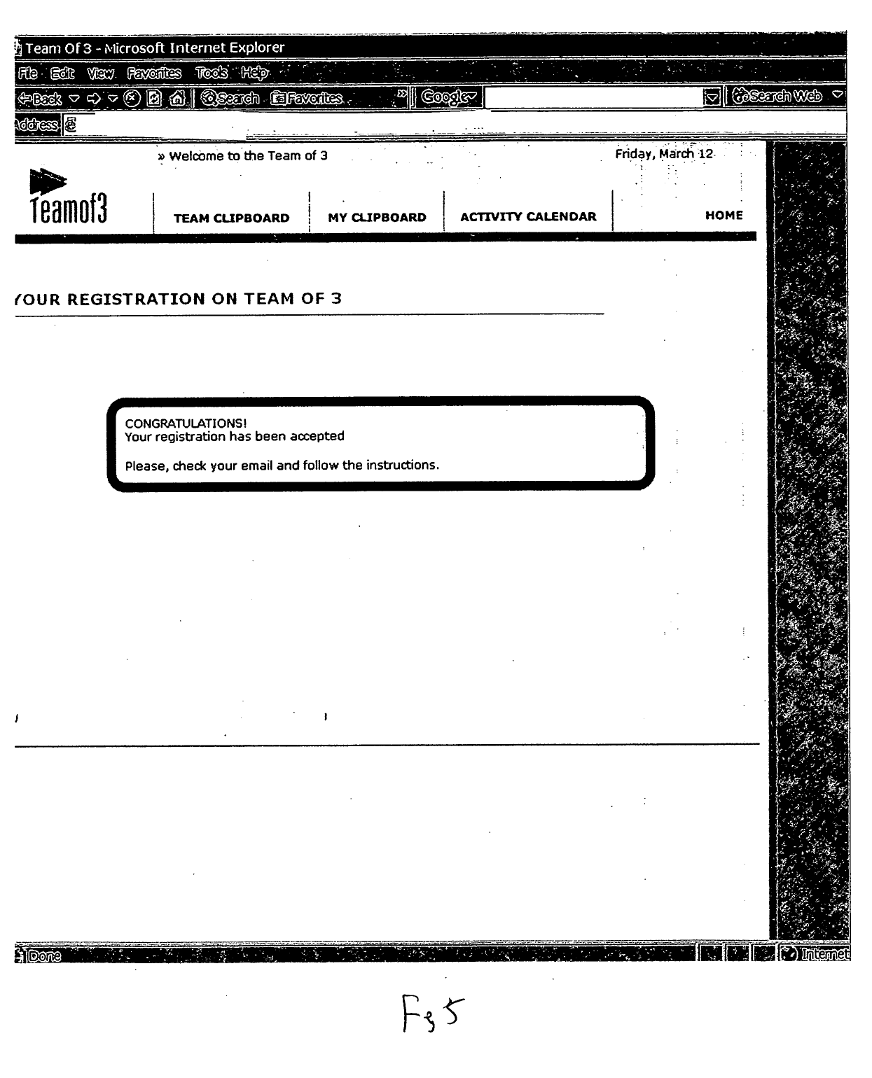

When a user has completed registration for a team or for an individual user, notification is sent that the registration has been accepted, as shown in FIG. 5.

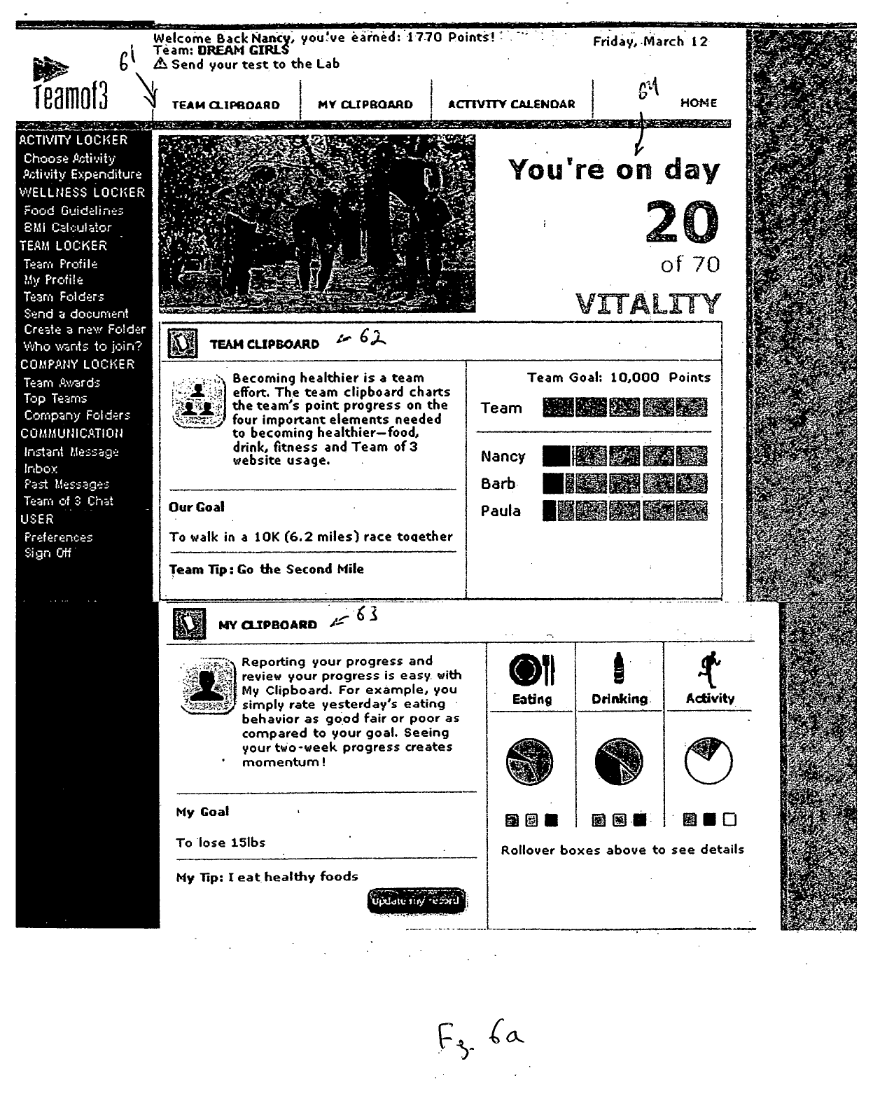

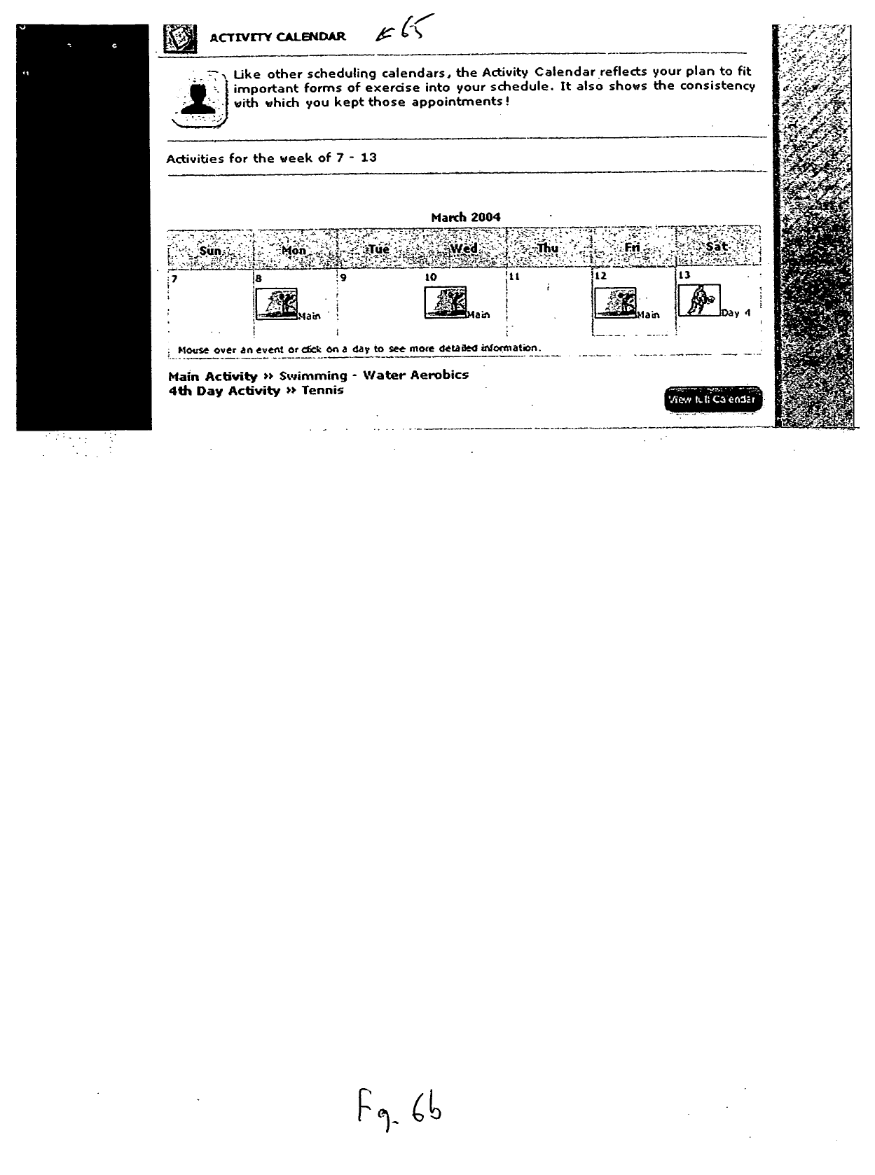

FIGS. 6a and 6b show a page that a user is directed to once he is logged in. On the left side of the page, a plurality of selections may be made including such items as activity locker, wellness locker, team locker, company locker, communication, and user, each of which has sub corresponding activities 60. A series of tabs 61 indicate that the user may select any of a team clipboard, my clipboard, or activity calendar. FIG. 6a shows the team clipboard 62 and my clipboard portions of the Web page. The team clipboard is concerned with the performance of team members and is key to the invention. The cooperation among the team members as reported on the team clipboard toward the team goal, as well as individual contributions of the team members, are shown to be a team effort. The “my clipboard” section of the Web page shows the personal goals for each team member. Thus, a team member logged in to the Team of 3 Web site would see a personal clipboard along with the member's personal goals, as shown on the page. Teams operate toward a team goal, as well as personal goals, over a defined period of time, which on FIG. 6a is shown to be 70 days, where the report on FIG. 6a is the report for day 20 of 70 days 64. FIG. 6b shows the activity calendar for a particular week for the team 65.

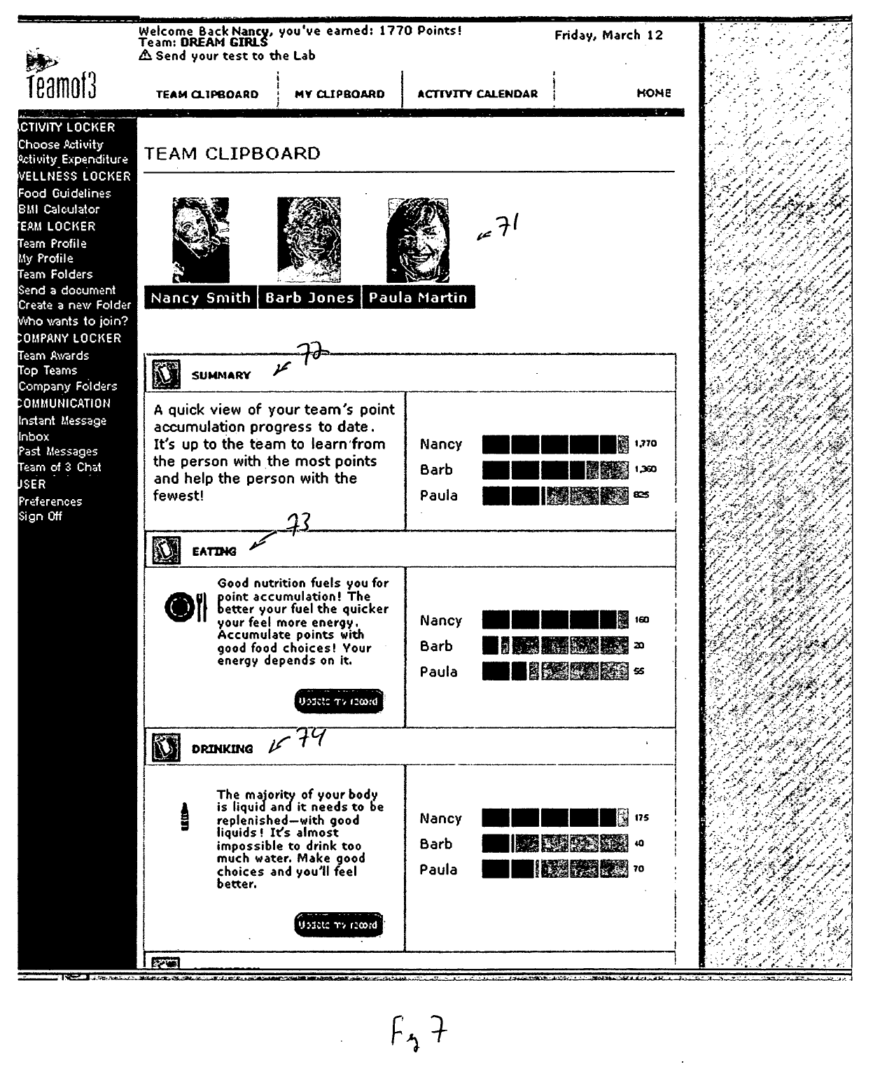

FIG. 7 is a team clipboard showing the team members 71 and providing a summary of the team's points accumulated toward the team goal 72, the team's eating habits 73, and the team's drinking habits 74.

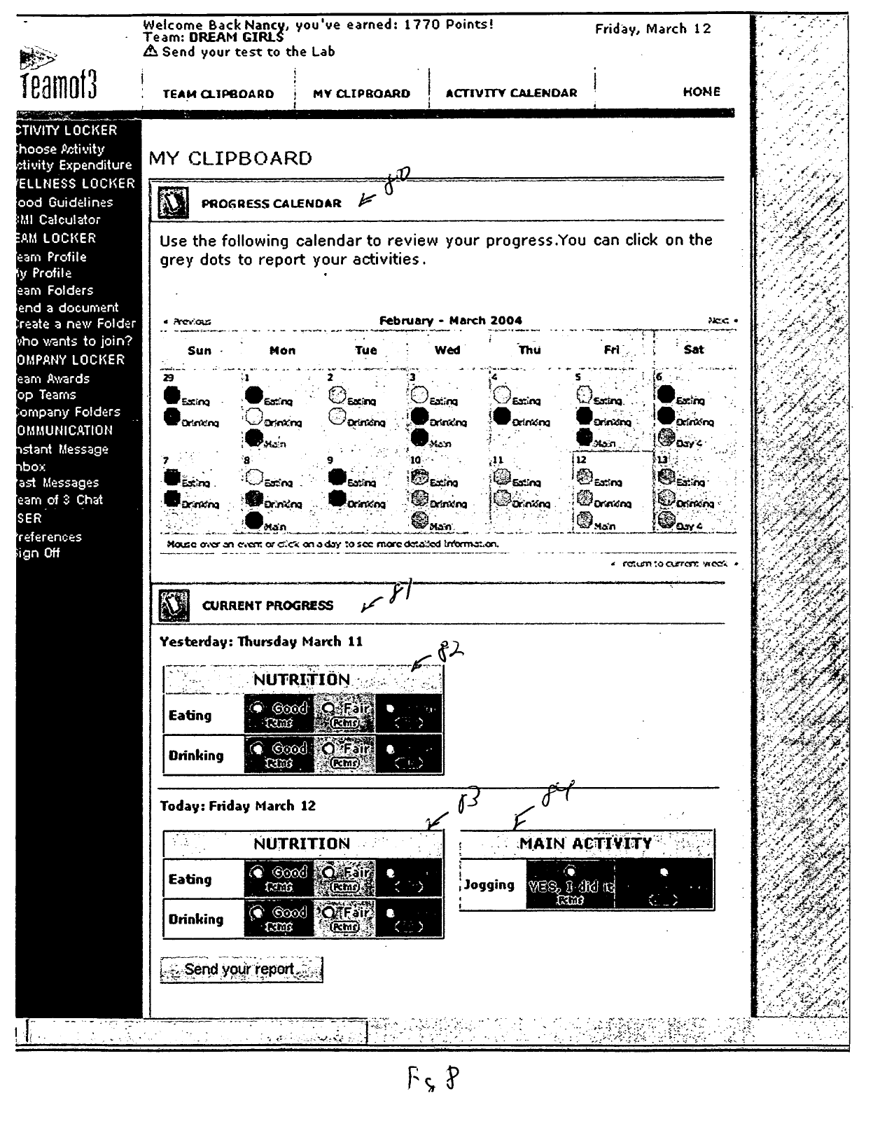

FIG. 8 shows the “my clipboard page” and includes a progress calendar 80 which shows the progress of the individual against goals set, the current progress of the individual 81 both with regard to nutrition and activities, both for a previous day, e.g. for nutrition 82 and for a present day, e.g. for nutrition 83 and main activities 84.

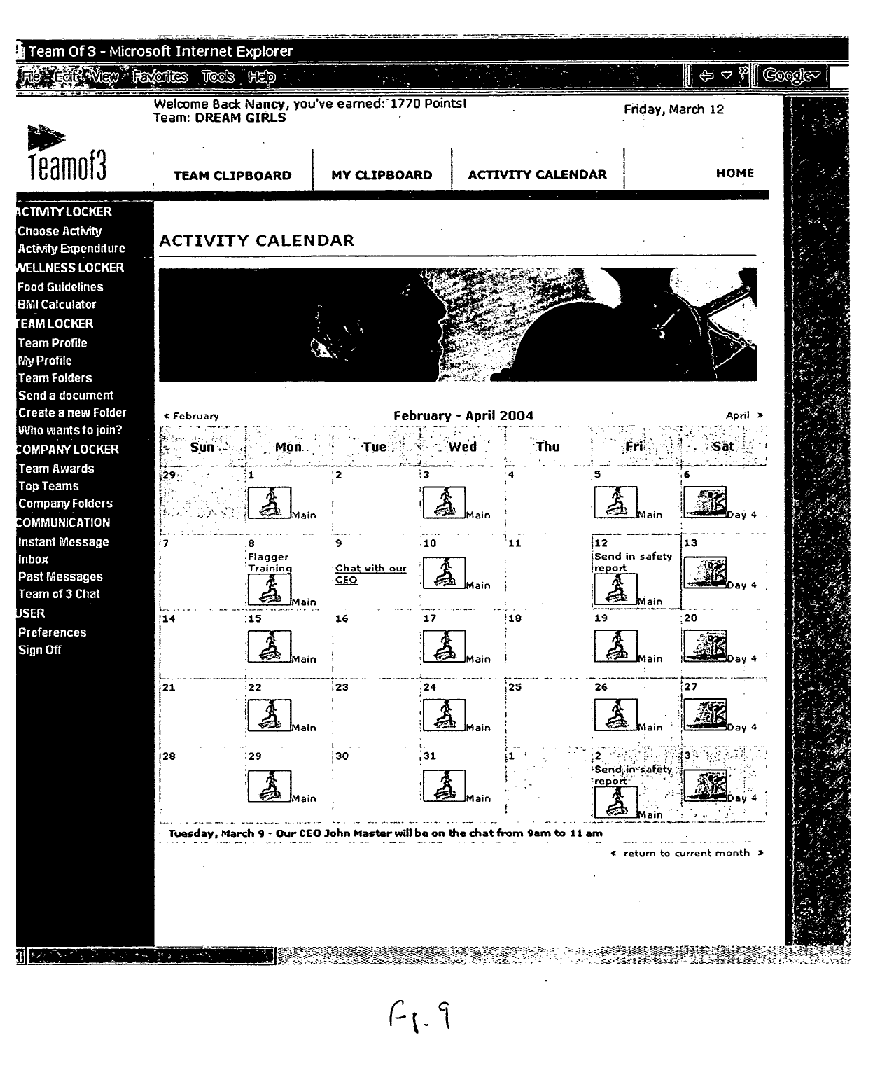

FIG. 9 shows an activity calendar for the Team of 3 embodiment of the invention.

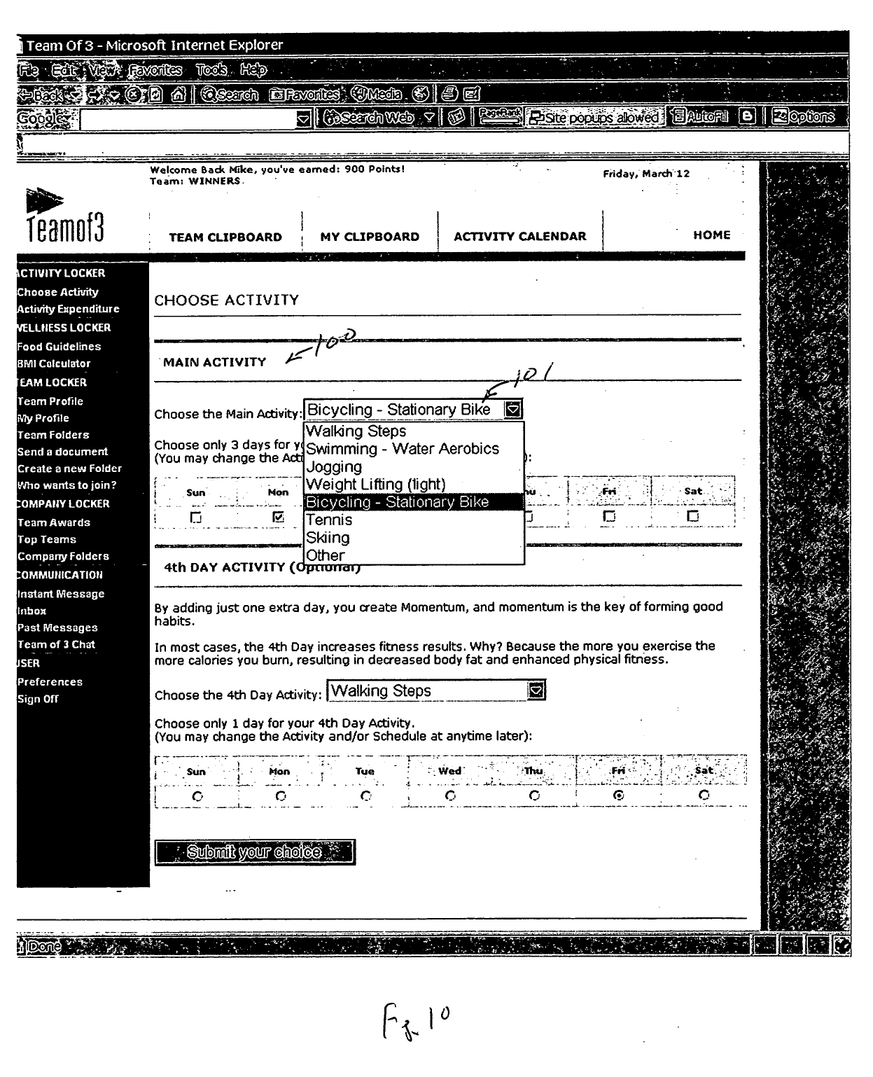

FIG. 10 is an activity scheduling page. On FIG. 10 a main activity 100 is shown, where the user may use a drop down menu to select an activity, such as bicycling on a stationary bike 101.

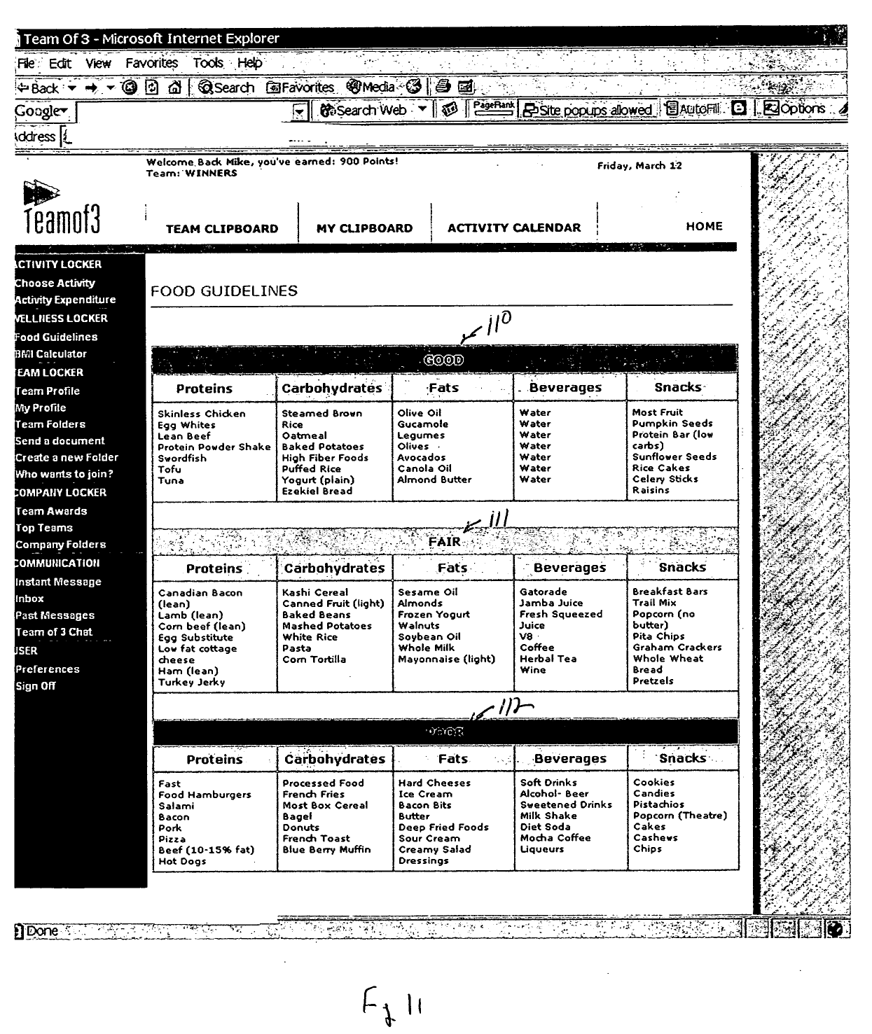

FIG. 11 shows a food guidelines Web page for the Team of 3 Web site, where team members are given guidance with regard to good food to eat for their health 110, foods that are of fair value 111, and foods that are poor 112.

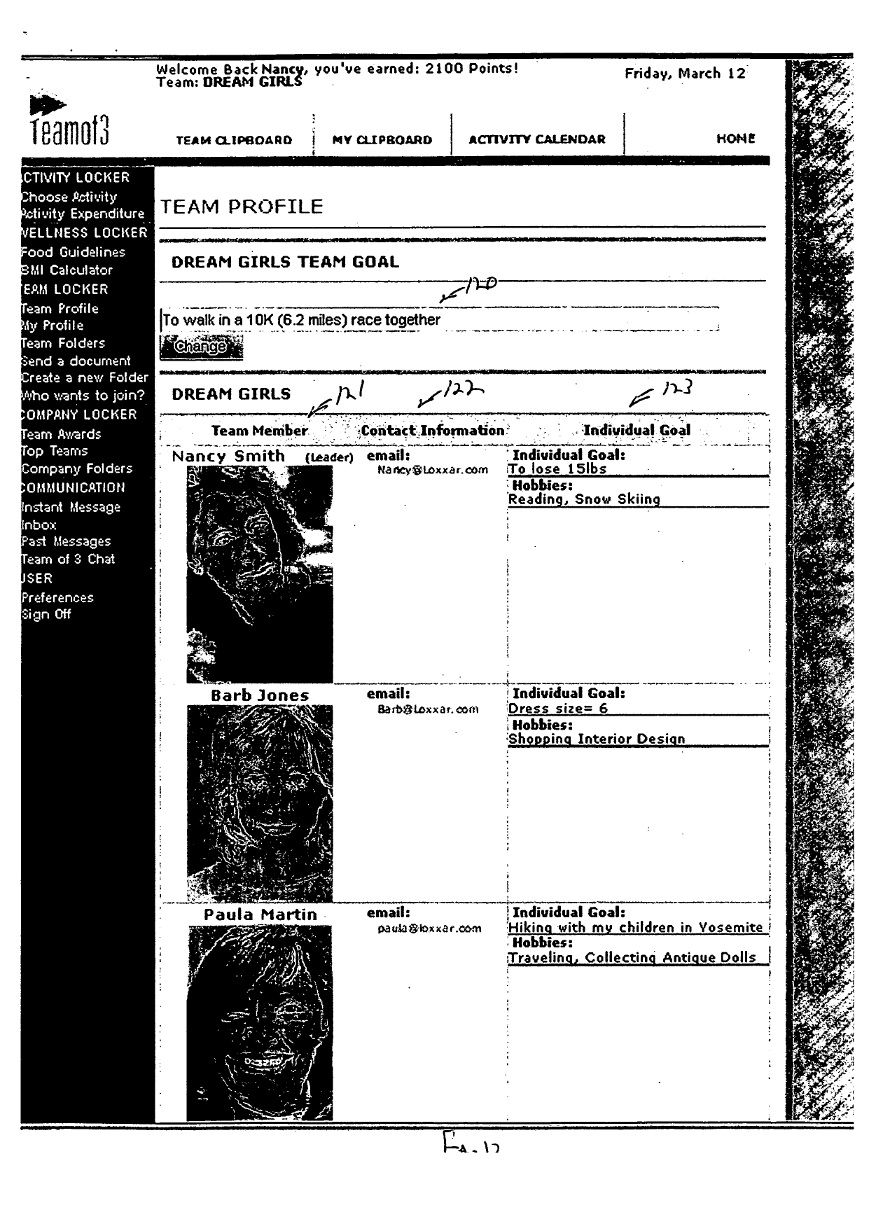

FIG. 12 is a team profile for a team and the Team of 3. The team has a goal 120, which in this case is to walk in a 10 K race together. The team profiles for the individuals are also shown by team member 121 along with contact information for the team member 122, and the team member's individual goal 123.

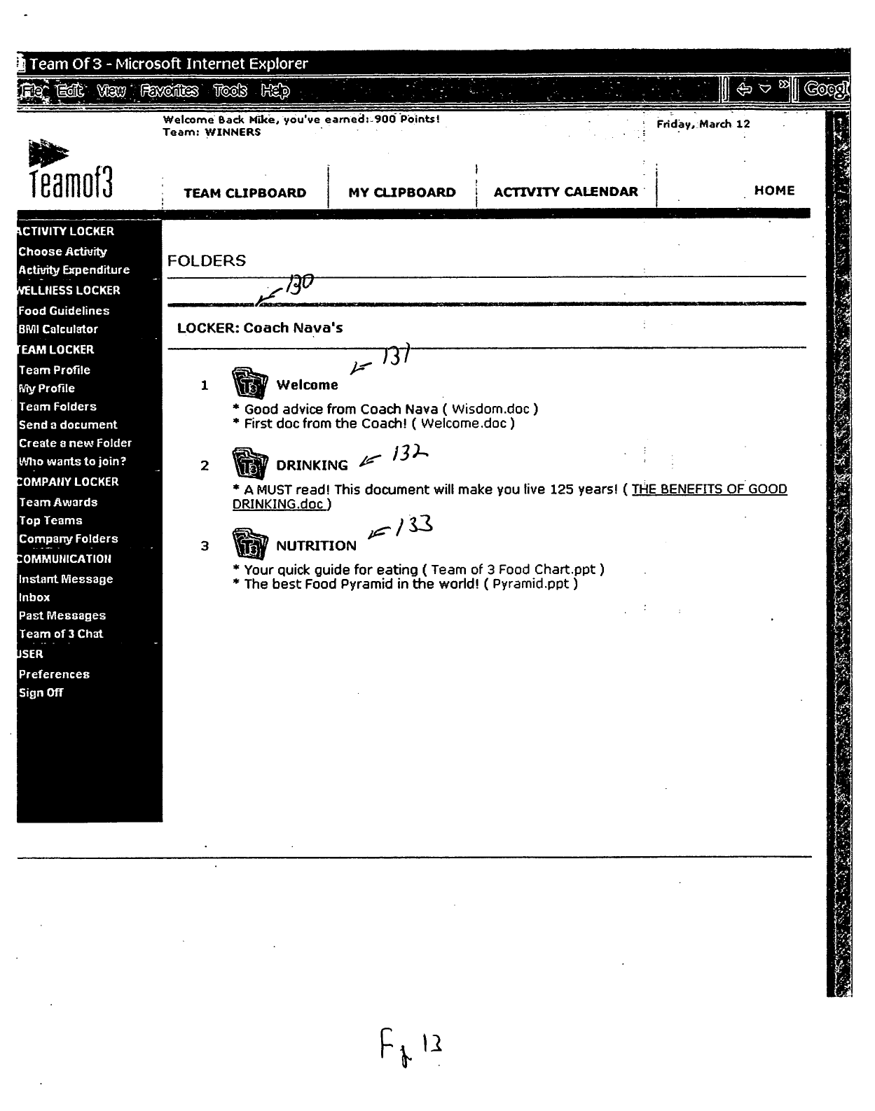

FIG. 13 shows a folders section of the Team of 3 Web site. In the example on

FIG. 13, the folder is a locker 130 for Coach Nava. In the coach's locker is various information that the team members may access to provide guidance during their participation in the Team of 3 program. Thus, information is provided to motivate and welcome team members 131, as well as information on good drinking habits 132 and on nutrition habits 133.

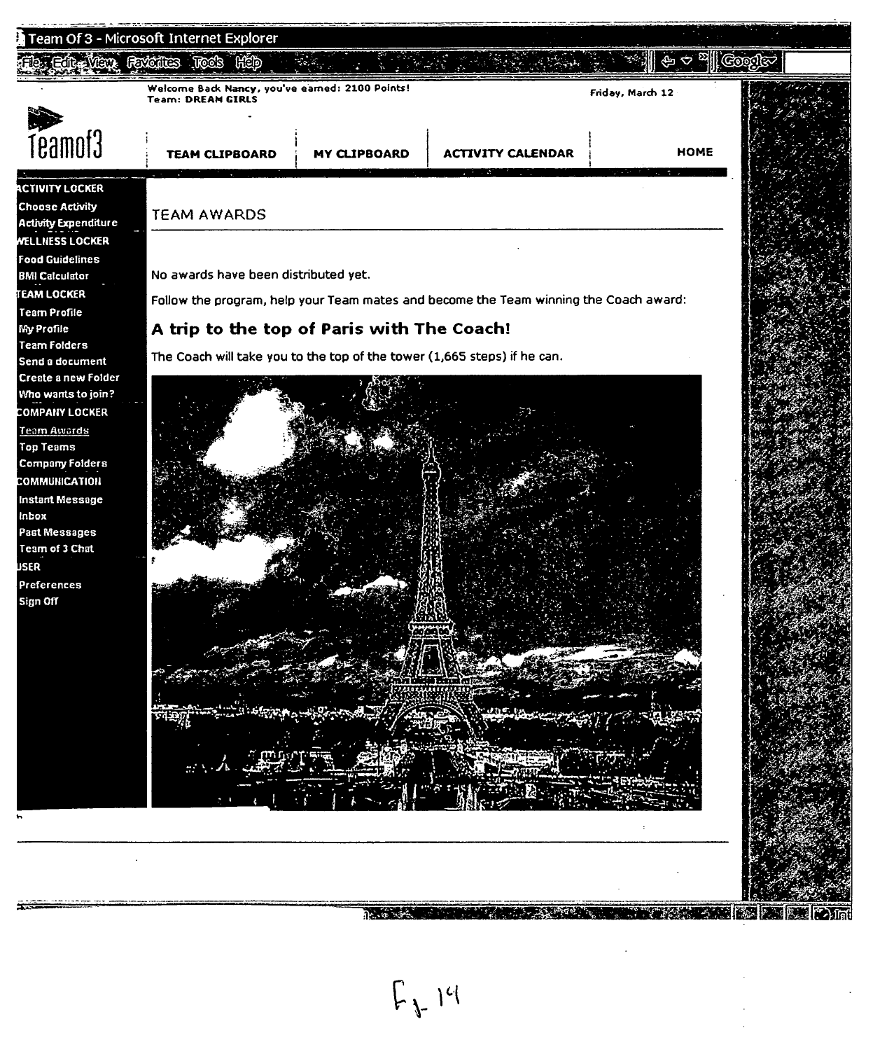

The Team of 3 is considered an organizational program in which teams may compete against other teams, for example an organization such as a corporation. Thus, a team awards page, as shown in FIG. 14, is provided that shows progress toward obtaining awards and the awards that are achieved once the goals are met by the team members.

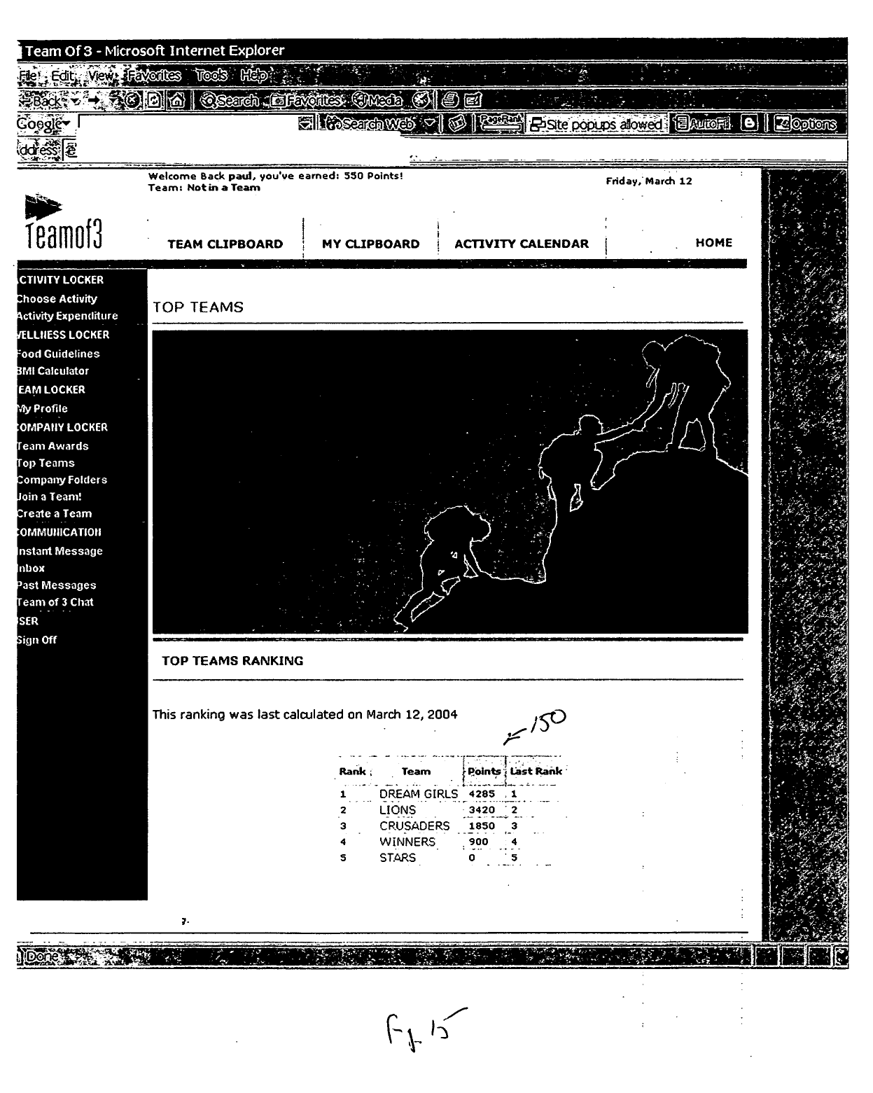

In keeping with the organizational orientation of the invention, the teams are also ranked, as is shown in FIG. 15, where the ranking of the teams is provided in a table 150 that includes rank, team name, points, and last rank.

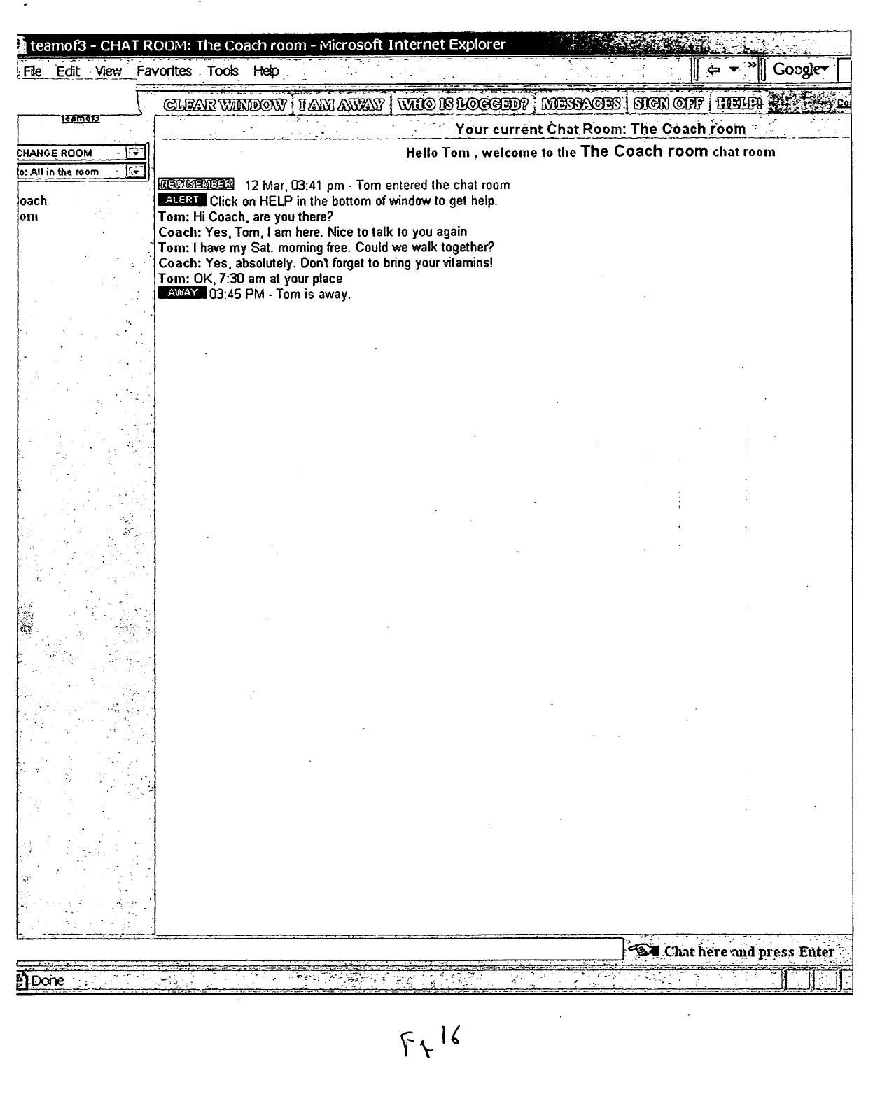

The invention also provides a communications module, such as a chat room as shown in FIG. 16. In this example, the team coach is in the chat room and is answering questions for team members from various teams. Those skilled in the art will appreciate that the invention complements the use of any communication means including, for example, email, instant messaging, and the like.

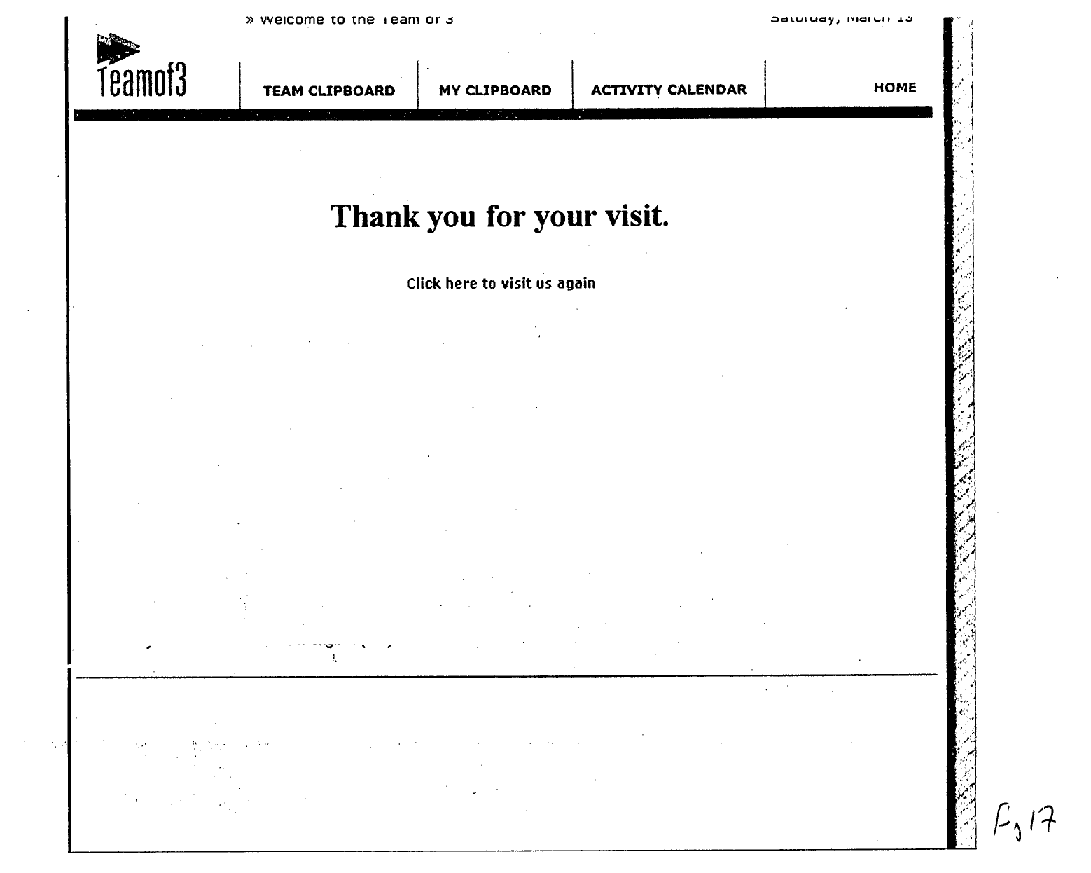

When the user is finished with the session at the Team of 3 Web site, he logs off and is provided with the log off screen as shown in FIG. 17.

The Team of 3 embodiment discussed above in connection with FIGS. 1-17 is readily adapted by those skilled in the art to implement the Cord of 3 embodiment.

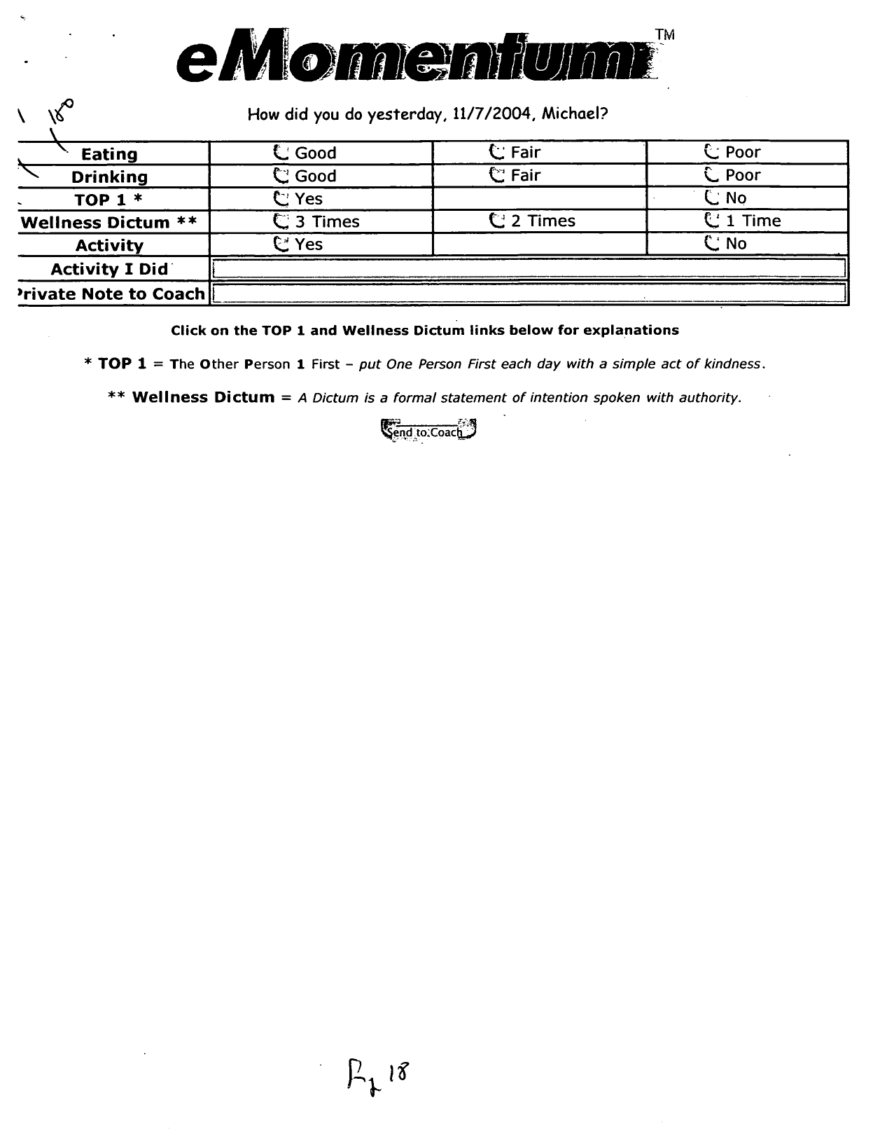

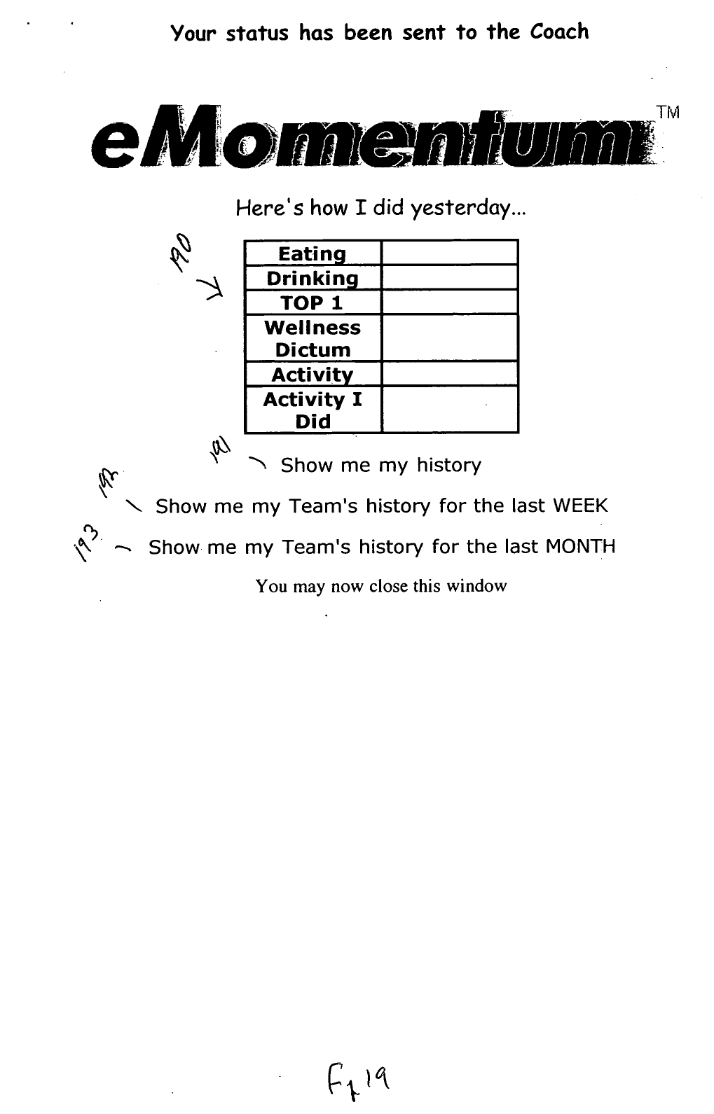

A further embodiment of the invention is referred to as the eMomentum™ program. In the eMomentum™ program a user, who may be a Team of Three or Cord of 3 participant, receives notifications, such as emails, instant messages, or the like on a regular basis, typically daily. The user selects a link in the message and user is provided with a form, as is shown in FIG. 18, which asks the user to report on various wellness related activities, such as eating 180, drinking 181, TOP 1 activities 182, as discussed above, wellness dictum 183, as discussed above, the user engaged in any activities or failed to engage in an activity 184, the activity engaged in, if any, 185, and if desired, a private note to the coach who is administering the program 186. To complete the form, the user is first forwarded to the eMomentum™ system, although other mechanisms can be used to communicate a user's information to the system.

The user is taken to an eMomentum™ Web page, which indicates that the daily status has been sent to the coach, as shown in FIG. 9. The user is provided with a table 190 that summarizes the user's entry. The user is also given the opportunity to request additional information such as the user's history 191, and the team's performance for a week 192 or for a month 193.

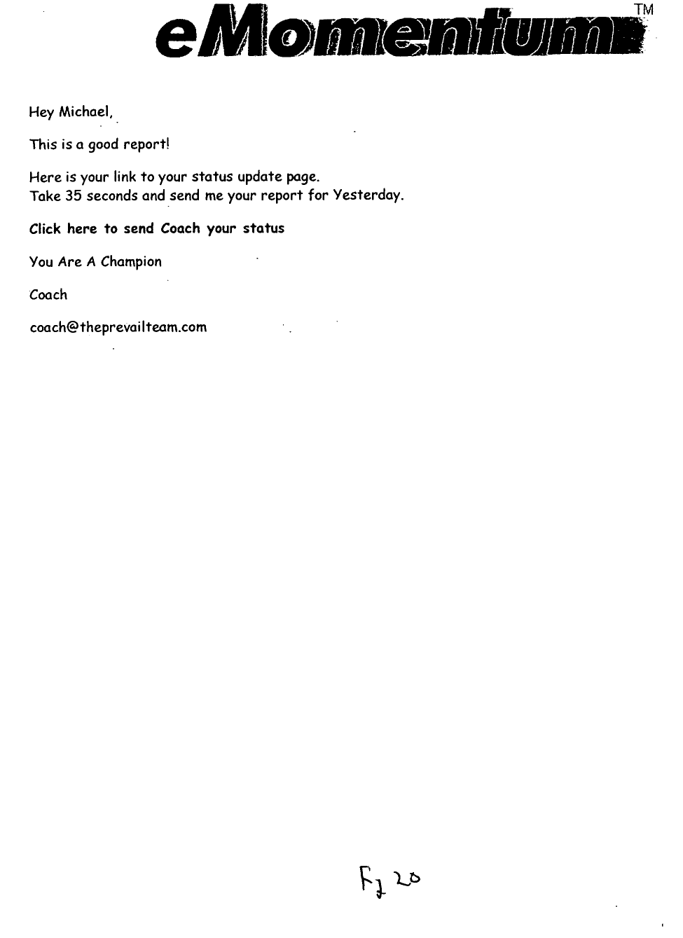

After the user submits his status information, he is provided with an email or other message, typically the next day, as shown in FIG. 20. This provides a motivational message to the user in response to the report submitted and provides a link for the user to send another message containing information on the user's next day activities.

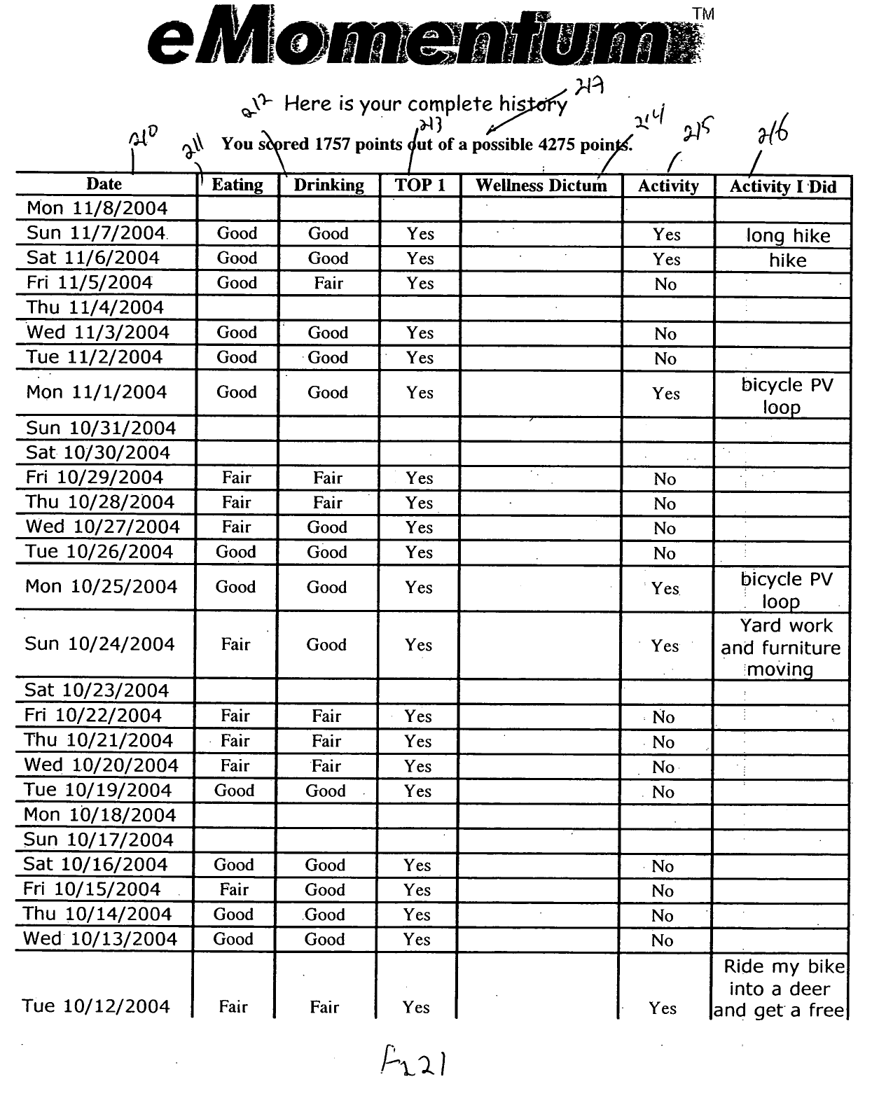

FIG. 21 shows a user history. In FIG. 21 information, each date 210 is shown with a column indicating performance of the individual with regard to eating 211, drinking 212, TOP 1 213, wellness dictum 214, whether or not an activity was done 215, and the activity performed 216. The user is provided with a score 217 of points achieved out of the total number of points available.

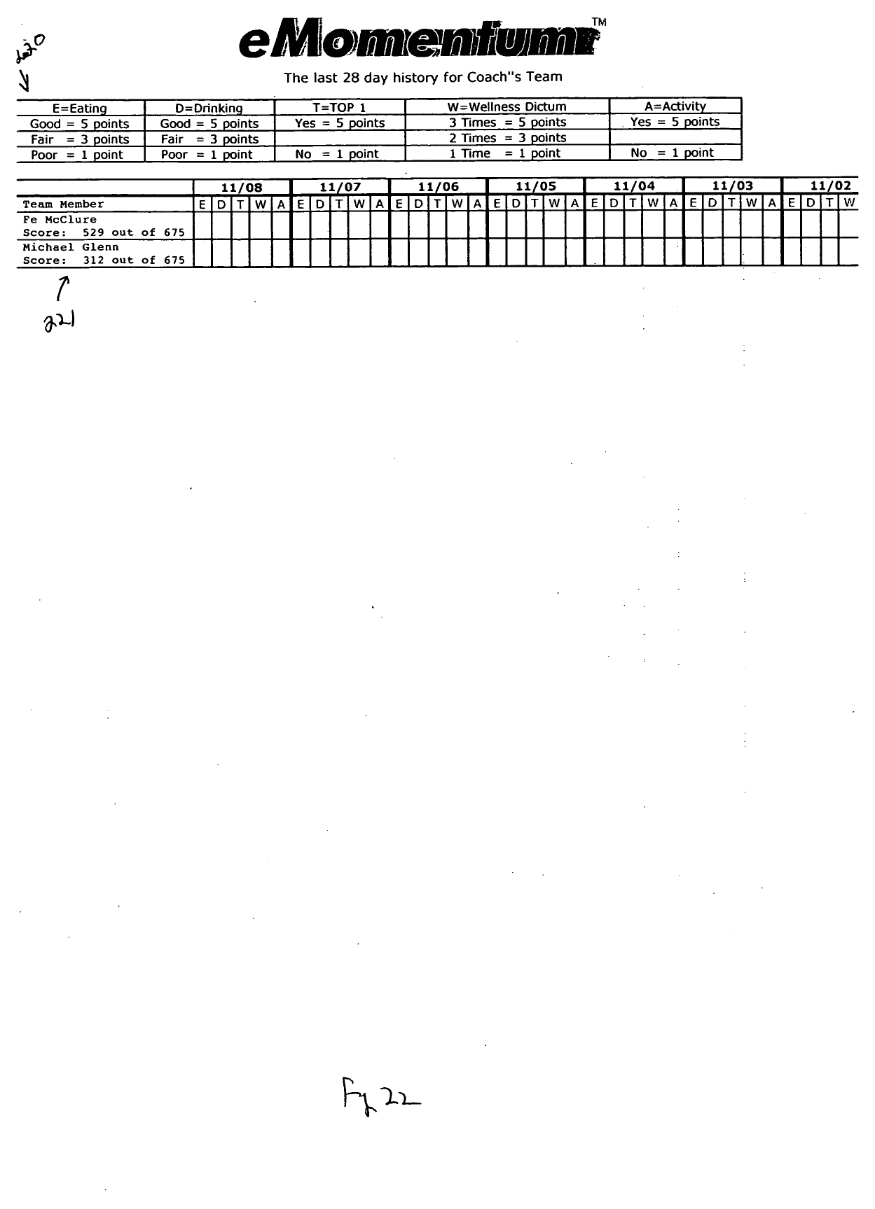

FIG. 22 shows a team performance for team members with regard to the various activities discussed in connection with the eMomentum™ program, i.e. eating, drinking, TOP 1, wellness dictum, and activity. The point breakdown is indicated in tabular form 220 and the team member performance over time is indicated in a further table 221.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A team-based, computer-implemented accountability method, comprising the steps of:
establishing a Team of 3 individuals having shared goals and mutual accountability;
establishing a computer-implemented communications medium for said term of three individuals; and
each individual of said Team of 3 individuals using said communications medium in connection with progressing towards completion of said shared goals and to maintain said mutual accountability.

2. The method of claim 1, wherein said mutual goals comprise any of spiritual, physical, emotional, mental, directional, and nutritional goals.

3. The method of claim 1, wherein said individuals who comprise said Team of 3 individuals are members of a common organization.

4. The method of claim 1, wherein a plurality of Teams of 3 individuals compete against each other pursuant to completion of each team's goals.

5. The method of claim 1, wherein said goals are to be accomplished during a predetermined interval, wherein said interval is preferably monthly in duration.

6. An online accountability system, comprising:
a website for establishing a Team of 3 individuals, said individuals having shared goals and being accountable to each other;
said goals comprising any of spiritual, physical, emotional, mental, directional, and nutritional goals;
said website receiving information from each of said individuals' progress towards said goals;
said website displaying said information to said individuals.

7. A human wellness and energy method, comprising the steps of:
providing an individual with a mechanism for participating as a member in a Team of 3 individuals, said team members having shared goals and being mutually acceptable to each other;
providing said individual with a mechanism for establishing a plurality of daily dictums; and
establishing an interval of predetermined duration, preferably 10 weeks, for completion of said goals.
